(19) United States
(12) Patent Application Publication
(10) Pub. No.: US 2025/0373385 A1
(43) Pub. Date: Dec. 4, 2025

(54) SYSTEMS, APPARATUSES, METHODS, AND NON-TRANSITORY COMPUTER-READABLE STORAGE DEVICES FOR WIRELESS COMMUNICATION EMPLOYING MIXED DISTRIBUTIVE RESOURCE UNITS AND REGULAR RESOURCE UNITS

(71) Applicant: HUAWEI TECHNOLOGIES CO., LTD., Shenzhen (CN)

(72) Inventors: Sara Norouzi, Vancouver (CA); Yan Xin, Kanata (CA); Jung Hoon Suh, Kanata (CA); Osama Aboul-Magd, Kanata (CA); Mahmoud Hasabelnaby, Kelowna (CA)

(21) Appl. No.: 18/917,006

(22) Filed: Oct. 16, 2024

Related U.S. Application Data
(60) Provisional application No. 63/652,771, filed on May 29, 2024.

(51) Int. Cl. H04L 5/00

(52) U.S. Cl. CPC H04L 5/0048; H04L 5/0007; H04L 5/0046; H04L 5/0098

(57) ABSTRACT

Embodiments described herein include tone distribution methods for designing a hybrid orthogonal frequency-division multiple access (OFDMA) physical layer protocol data unit (PPDU) employing mixed regular resource units (RRUs) and distributed resource units (DRUs). The plurality of subcarriers of each DRU are same subcarriers determined in accordance with a design method that distributes the subcarriers. The plurality of subcarriers of each RRU are arranged consecutively. Various signaling methods are described for transmission of a hybrid PPDU. The signaling methods use current RU allocation fields and introduce additional signaling information for determining the tone distribution of a hybrid PPDU.

### CROSS-REFERENCE TO RELATED APPLICATION

This application claims the benefit of U.S. Provisional Patent Application Ser. No. 63/652,771, filed May 29, 2024, entitled “SYSTEMS, APPARATUSES, METHODS, AND NON-TRANSITORY COMPUTER-READABLE STORAGE DEVICES FOR WIRELESS COMMUNICATION EMPLOYING MIXED DISTRIBUTIVE RESOURCE UNITS AND REGULAR RESOURCE UNITS”, the content of which is incorporated herein by reference in its entirety.

### FIELD OF THE DISCLOSURE

The present disclosure relates generally to communication systems, apparatuses, methods, and non-transitory computer-readable storage devices, and in particular to systems, apparatuses, methods, and non-transitory computer-readable storage devices for wireless communication employing mixed distributive resource units and regular resource units.

### BACKGROUND

Wireless communication systems including IEEE 802.11ac (WI-FI® 5; WI-FI is a registered trademark of Wi-Fi Alliance, Austin, TX, USA), IEEE 802.11ax (WI-FI® 6), IEEE 802.11be (WI-FI® 7) and future generation systems may need to meet government-regulated power spectral density (PSD) requirements, which lay the limit in the upper bound on the transmitter (TX) power at, for example, every one (1) megahertz (MHz). The total TX power has also been regulated.

In wireless communication systems (such as IEEE 802.11ax (WI-FI® 6)) using orthogonal frequency division multiple access (OFDMA; which uses orthogonal frequency division multiplexing (OFDM) for multiple access), the resource unit (RU) is the OFDMA scheduling unit. In conventional wireless communication technologies, an RU usually only occupies a sub-bandwidth of consecutive subcarriers of the OFDM frame according to the size of the RU. When using OFDMA, different RUs may be used with different TX power. However, the government-regulated PSD requirements limit the TX power that can be used in RUs, thereby posing constraints on the RU designs. Moreover, flexibility is desired for the designs of RUs, depending on the varying applications of users using the OFDMA for transmission at the same time.

### SUMMARY

According to one aspect of this disclosure, there is provided a first communication method comprising: transmitting a signal to a device using a resource unit (RU) in an orthogonal frequency-division multiple access (OFDMA) physical layer protocol data unit (PPDU), wherein the RU is one of a plurality of RUs of the OFDMA PPDU; wherein the plurality of RUs comprises a first set including at least one first RU and a second set including at least one second RU, each first RU of the first set comprises a plurality of first subcarriers for data and/or pilot-symbol transmission and each second RU of the second set comprises a plurality of second subcarriers for data and/or pilot-symbol transmission; and wherein the plurality of first subcarriers of each first RU of the first set are same subcarriers determined in accordance with a design method that distributes the first subcarriers, and the plurality of second subcarriers of each second RU of the second set are arranged consecutively.

In some embodiments, the design method comprises shuffling first subcarrier indices of the first subcarriers using a relative prime interleaving method.

In some embodiments, the design method further comprises: for each first RU of the first set of the plurality of RUs, adjusting the first subcarrier indices of the first subcarriers of the first RU to be concatenated with a corresponding left neighboring first RU of the first set; and wherein said shuffling the first subcarrier indices of the first subcarriers comprises shuffling the adjusted first subcarrier indices of the first subcarriers.

In some embodiments, the design method further comprises: for each second RU of the second set of the plurality of RUs, if a distributed first subcarrier index falls within a second subcarrier index of the second set of the plurality of RUs, right shifting said distributed first subcarrier index and following distributed first subcarrier indices by a length of total second subcarriers in the corresponding second RU.

In some embodiments, the design method comprises: for each first RUᵢ of the first set of the plurality of RUs, where i belongs to a unit index of the first set of the plurality of RUs: adjusting [sᵢ:eᵢ] to [s′ᵢ:e′ᵢ] to be concatenated with their corresponding left neighboring first RUs of the first set, where sᵢ is a starting first subcarrier index of RUᵢ, eᵢ is an ending first subcarrier index of RUᵢ, S′ᵢ is an adjusted starting first subcarrier index of RUᵢ, and e′ᵢ is an adjusted ending first subcarrier index of RUᵢ; shuffling a first subcarrier index of each first subcarrier within [s′ᵢ:e′ᵢ] using

$$k ( n ) = ( p \cdot n ) mod N$$

where n=s′ᵢ, . . . , e′ᵢ, k is a function of n, mod represents a modulo function, N is determined based on a total number of first subcarriers in the first set of the plurality of RUs, p is a minimum distance between two neighboring first subcarriers in each RU of the first set of the plurality of RUs and is a relative prime of N such that p and N have no common factors other than one; and for each second RU of the second set of the plurality of RUs, if a shuffled first subcarrier index k(n) falls within a second subcarrier index of the second set of the plurality of RUs, right shifting said shuffled first subcarrier index k(n) and following shuffled first subcarrier indices k(n+1), . . . k(e′ᵢ) by a length of total second subcarriers in the corresponding second RU.

In some embodiments, N corresponds to a total subcarrier number of the first subcarriers in the first set of the plurality of RUs minus 1; and the design method further comprises removing a last one first subcarrier from a last first RU of the first set of the plurality of RUs before said shuffling and inserting the last one first subcarrier at an end of the last first RU of the first set of the plurality of RUs after said shuffling.

In some embodiments, p is determined based on the structure of RUs such that it is a relative prime of N and can correspond to the total unit number of the first set of the plurality of RUs when the RUs in the first set of the plurality of RUs are sized equally.

In some embodiments, the second set of the plurality RUs are arranged at an end of the PPDU.

According to one aspect of this disclosure, there is provided a second communication method, comprising: receiving a first signal of an OFDMA PPDU; and transmitting a second signal to a device using an RU in the OFDMA PPDU, the RU comprising a plurality of subcarriers; wherein the RU is one of a plurality of RUs of the OFDMA PPDU; wherein the RU belongs to either a first set including at least one first RU or a second set including at least one second RU; wherein if the RU belongs to the first set, the plurality of subcarriers of the RU are same subcarriers determined in accordance with a design method that distributes the subcarriers, and if the RU belongs to the second set, the plurality of subcarriers of the RU are arranged consecutive; and wherein the first signal comprises resource allocation information of the plurality of RUs in the OFDMA PPDU; and wherein the plurality of subcarriers of the RU in the OFDMA PPDU are determined using the resource allocation information of the plurality of RUs in the OFDMA PPDU.

In some embodiments, the first signal comprises at least one RU allocation field and an additional subfield, the at least RU allocation field indicates a size of each of the plurality of RUs in the OFDMA PPDU, and the plurality of subcarriers of the RU in the OFDMA PPDU are determined using the at least one RU allocation field and the additional subfield.

In some embodiments, the additional subfield comprises a first subfield for each RU in a user field of the first signal for indicating if the corresponding RU belongs to the first set of the plurality of RUs or the second set of the plurality of RUs.

In some embodiments, the first subfield comprises one bit for each RU in the user field of the first signal for indicating if the corresponding RU belongs to the first set of the plurality of RUs or the second set of the plurality of RUs.

In some embodiments, the additional subfield comprises a second subfield in a common field of the first signal for indicating a total number of second RUs in the second set of the plurality of RUs.

In some embodiments, the second subfield comprises 1 to 8 bits for indicating the total number of second RUs in the second set of the plurality of RUs.

In some embodiments, the second set of the plurality of RUs are arranged at an end of the PPDU.

In some embodiments, each of the at least one RU allocation subfield corresponds to a subchannel of the OFDMA PPDU, and the additional subfield comprises one additional bit in each of the at least one RU allocation subfield for indicating if RUs in a corresponding subchannel belong to the first set of the plurality of RUs or the second set of the plurality of RUs.

According to one aspect of this disclosure, there is provided a third communication method, comprising: transmitting a first signal of an OFDMA PPDU; wherein the OFDMA PPDU comprises a plurality of RUs, the plurality of RUs comprises a first set including at least one first RU and a second set including at least one second RU, each first RU of the first set comprises a plurality of first subcarriers for data and/or pilot-symbol transmission and each second RU of the second set comprises a plurality of second subcarriers for data and/or pilot-symbol transmission; and wherein the plurality of first subcarriers of each first RU of the first set are same subcarriers determined in accordance with a design method that distributes the first subcarriers, and the plurality of second subcarriers of each second RU of the second set are arranged consecutively; and wherein the first signal comprises at least one RU allocation field for indicating a size of each of the plurality of RUs in the OFDMA PPDU and an additional subfield, wherein the first signal comprises resource allocation information of the plurality of RUs in the OFDMA PPDU, and the resource allocation information is used to determine parameters used in the design method that distributes the first subcarriers.

In some embodiments, the design method comprises shuffling first subcarrier indices of the first subcarriers using a relative prime interleaving method; and the first signal comprises at least one RU allocation field and an additional subfield, the at least RU allocation field indicates a size of each of the plurality of RUs in the OFDMA PPDU, and the parameters used in the design method that distributes the first subcarriers are determined using the at least one RU allocation field and the additional subfield.

In some embodiments, the additional subfield comprises a first subfield for each RU in a user field of the first signal for indicating if the corresponding RU belongs to the first set of the plurality of RUs or the second set of the plurality of RUs.

In some embodiments, the first subfield comprises one bit for each RU in the user field of the first signal for indicating if the corresponding RU belongs to the first set of the plurality of RUs or the second set of the plurality of RUs.

In some embodiments, the additional subfield comprises a second subfield in a common field of the first signal for indicating a total number of second RUs in the second set of the plurality of RUs.

In some embodiments, the second subfield comprises 1 to 8 bits for indicating the total number of second RUs in the second set of the plurality of RUs.

In some embodiments, each of the at least one RU allocation subfield corresponds to a subchannel of the OFDMA PPDU, and the additional subfield comprises one additional bit in each of the at least one RU allocation subfield for indicating if RUs in a corresponding subchannel belong to the first set of the plurality of RUs or the second set of the plurality of RUs.

According to one aspect of this disclosure, there is provided a fourth communication method comprising: receiving a first signal of an orthogonal frequency-division multiple access (OFDMA) physical layer protocol data unit (PPDU); determining a plurality of subcarriers of a resource unit (RU) in the OFDMA PPDU based on the first signal; and transmitting a second signal to a device using the determined RU; wherein the RU is one of a plurality of RUs of the OFDMA PPDU; wherein the RU belongs to either a first set including at least one first RU or a second set including at least one second RU; wherein if the RU belongs to the first set, the plurality of subcarriers of the RU are same subcarriers determined in accordance with a design method that distributes the subcarriers, and if the RU belongs to the second set, the plurality of subcarriers of the RU are arranged consecutive; and wherein the first signal comprises at least one RU allocation field for indicating a size of each of the plurality of RUs in the OFDMA PPDU and an additional subfield, wherein the plurality of subcarriers of the RU in the OFDMA PPDU are determined using the at least one RU allocation field and the additional subfield.

According to one aspect of this disclosure, there is provided one or more circuits, such as at least one processing unit or at least one processor, for performing above-described first and/or second methods.

According to one aspect of this disclosure, there is provided one or more non-transitory computer-readable storage devices comprising computer-executable instructions, wherein the instructions, when executed, cause one or more circuits, such as at least one processing unit or at least one processor, to perform above-described first, second, third and/or fourth methods.

The methods, circuits, non-transitory computer-readable storage devices, and systems disclosed herein provide a systematic way to allocate or determine subcarriers (that is, tones) in a hybrid OFDMA PPDU including mixed regular RUs (RRUs) and distributed RUs (DRUs) using a tone distribution method based on e.g., a (modified) relative prime interleaving.

The various embodiments employing the hybrid OFDMA PPDU or mixed DRU & RRU can increase flexibility of RU allocations in the hybrid PPDU, taking into consideration RUs that are designated for RRUs or DRU incapable STAs. The hybrid OFDMA PPDU or mixed DRU & RRU, where DRUs and RRUs are used at the same time for an OFDMA PPDU transmission, can achieve higher throughput and better spectral efficiency. Moreover, DRU incapable stations (STAs) can be accommodated using the tone distribution method according to the embodiments. Various embodiments employing the hybrid OFDMA PPDU or mixed DRU & RRU can apply to a variety of PPDU bandwidths without limitations to the sizes of DRU and/or RRU segments.

The methods, circuits, non-transitory computer-readable storage devices, and systems disclosed herein also provide various signaling methods for transmission using a hybrid PPDU. The various signaling methods make use of current resource allocation field(s) and provide extra signaling information that can be used to determine the RU allocation of the hybrid PPDU and parameters used in the tone distribution methods of the DRUs.

By using the tone distribution methods based on the (modified) relative prime interleaving, the indices for the hybrid PPDU can be generated or determined “on-the-fly” with easy implementation. Extra signaling information is introduced for transmission using a hybrid PPDU which maintains a healthy balance between flexibility of the hybrid PPDU designs and signaling overhead.

The tone distribution and/or signaling methods disclosed herein may be related to the standardization of next generation of IEEE 802.11be for operation on the unlicensed millimeter bands.

The tone distribution and/or signaling methods disclosed herein may be used in WI-FI APs and STAs with operating capability in both sub-7 GHz and millimeter bands.

### BRIEF DESCRIPTION OF THE DRAWINGS

FIG. 1 is a simplified schematic diagram showing a communication system, according to some embodiments of this disclosure;

FIG. 2 is a simplified schematic diagram of an access point (AP) of the communication network of the communication system shown in FIG. 1;

FIG. 3 is a simplified schematic diagram of a station (STA) of the communication system shown in FIG. 1;

FIGS. 4A and 4B are schematic diagrams showing regular RUs (RRUs) (FIG. 7A) and distributed RUs (DRUs) (FIG. 7B);

FIG. 5 is a table showing transmitter (TX) power for RRU and DRU over different bandwidths;

FIG. 6 is a schematic diagram showing an example of a hybrid Physical Layer Protocol Data Unit (PPDU) having mixed DRUs and RRUs;

FIG. 7 is a flowchart showing a DRU-design procedure using a (modified) relative prime interleaving;

FIG. 8(A) is a flowchart showing a tone design procedure for a hybrid PPDU with mixed DRUs and RRUs, according to some embodiments of this disclosure;

FIG. 8(B) is a flowchart showing a tone design procedure for a hybrid PPDU with mixed DRUs and RRUs using a (modified) relative prime interleaving, according to some embodiments of this disclosure;

FIG. 9 is a schematic diagram applying the steps of the procedure shown in FIG. 8 for an example hybrid PPDU with mixed DRUs and RRUs;

FIG. 10 is a schematic diagram showing an example of a hybrid PPDU having four (4) RUs where two are designated DRUs, and two are designated RRUs;

FIG. 11 is a schematic diagram showing a tone index sequence determined or allocated using the tone design procedure shown in FIG. 8, according to some embodiments of this disclosure;

FIG. 12 is a schematic diagram showing a tone index sequence shown in FIG. 11 after reordering;

FIG. 13 is a schematic diagram showing an example of a hybrid PPDU partitioning;

FIG. 14 is a schematic diagram showing an example of the hybrid PPDU with mixed DRUs and RRUs, obtained using the tone design procedure shown in FIG. 8;

FIG. 15 is a schematic diagram showing an example of a hybrid PPDU having mixed DRUs and RRUs, where RRUs are arranged at the end of the PPDU, according to some embodiments of this disclosure;

FIG. 16 is a schematic diagram showing an example of a hybrid PPDU having four (4) RUs where RRUs are arranged at the end of the PPDU;

FIG. 17 is a schematic diagram showing a tone index sequence determined or

allocated using a simplified tone design procedure shown in FIG. 8, according to some embodiments of this disclosure;

FIG. 18 is a schematic diagram showing a tone index sequence shown in FIG. 17 after reordering;

FIG. 19 is a schematic diagram showing a SIG field in a preamble of a physical layer PPDU signal;

FIG. 20 is a schematic diagram showing a SIG field in a preamble of a physical layer PPDU signal, including a first additional subfield in User Field, according to some embodiments of this disclosure;

FIG. 21 is a schematic diagram showing a SIG field in a preamble of a physical layer PPDU signal, including a second additional subfield in Common Field, according to some embodiments of this disclosure; and

FIG. 22 is a schematic diagram showing a SIG field in a preamble of a physical layer PPDU signal, including a modified RU allocation subfield, according to some embodiments of this disclosure;

FIG. 23 is a flow chart of a first communication method, in accordance with some embodiments of the disclosure;

FIG. 24 is a flow chart of a second communication method, in accordance with some embodiments of the disclosure;

FIG. 25 is a flow chart of a third communication method, in accordance with some embodiments of the disclosure.

### DETAILED DESCRIPTION

Embodiments disclosed herein relate to systems, apparatuses, methods, and non-transitory computer-readable storage devices for wireless communication employing mixed distributive resource units and regular resource units. The wireless communication systems, apparatuses, and methods disclosed herein may be any suitable systems, apparatuses, and methods for transmitting wireless signals. Examples of such systems may be wireless local-area network (WLAN) Ultra High Reliability (UHR) systems (for example, IEEE 802.11bn or WI-FI® 8 systems), 5G or 6G wireless mobile communication systems, and the like.

### A. System Structure

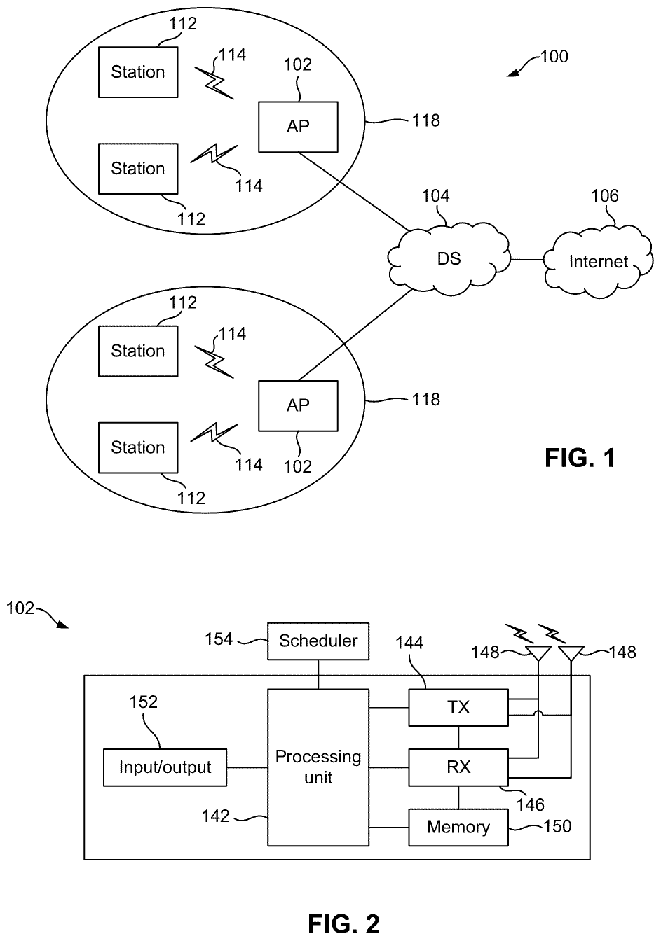

Turning now to FIG. 1, a communication system according to some embodiments of this disclosure is shown and is generally identified using reference numeral 100. As an example, the communication system 100 may be a WI-FI® system built under relevant standards such as IEEE 802.11 standard. As shown, the communication system 100 comprises a plurality of interconnected networking devices 102 such as a plurality of interconnected access points (APs; also called “base stations”) forming a distribution system (DS) 104 which is in turn connected to other networks such as the Internet 106 which may include a network of computers and subnets (intranets) or both, and incorporate protocols, such as Internet Protocol (IP), Transmission Control Protocol (TCP), User Datagram Protocol (UDP), and/or the like.

Each AP 102 is in wireless communication with one or more mobile or stationary stations 112 (STAs) through respective wireless channels 114 for providing wireless network connected thereto. Herein, the APs 102 and STAs 112 may be considered as different types of network nodes (or simply “nodes”) of the communication system 100. Each AP 102 and the STAs 112 connected thereto form a cell or basic service set (BSS) 118.

FIG. 2 is a simplified schematic diagram of an AP 102. As shown, the AP 102 comprises at least one processing unit 142 (also denoted at least one “processor”), at least one transmitter (TX) 144, at least one receiver (RX) 146 (collectively referred to as a transceiver), one or more antennas 148, at least one memory 150, and one or more input/output components or interfaces 152. A scheduler 154 may be coupled to the processing unit 142. The scheduler 154 may be included within or operated separately from the AP 102. Each of these components 142 to 154 may be implemented as one or more circuits (such as one or more electronic circuits and/or one or more optical circuits). Alternatively, the ensemble of these components 142 to 154 may be implemented as one or more circuits.

The processing unit 142 is configured for performing various processing operations such as signal coding, data processing, power control, input/output processing, or any other suitable functionalities. The processing unit 142 may comprise a microprocessor, a microcontroller, a digital signal processor, a FPGA, an ASIC, and/or the like. In some embodiments, the processing unit 142 may execute computer-executable instructions or code stored in the memory 150 to perform various the procedures (otherwise referred to as methods) described below.

Each transmitter 144 may comprise any suitable structure for generating signals, such as control signals as described in detail below, for wireless transmission to one or more STAs 112. Each receiver 146 may comprise any suitable structure for processing signals received wirelessly from one or more STAs 112. Although shown as separate components, at least one transmitter 144 and at least one receiver 146 may be integrated and implemented as a transceiver. Each antenna 148 may comprise any suitable structure for transmitting and/or receiving wireless signals. Although common antennas 148 are shown in FIG. 2 as being coupled to both the transmitter 144 and the receiver 146, one or more antennas 148 may be coupled to the transmitter 144, and one or more other antennas 148 may be coupled to the receiver 146.

In some embodiments, an AP 102 may comprise a plurality of transmitters 144 and receivers 146 (or a plurality of transceivers) together with a plurality of antennas 148 for communication in its cell 118.

Each memory 150 may comprise any suitable volatile and/or non-volatile storage such as RAM, ROM, hard disk, optical disc, SIM card, solid-state memory, memory stick, SD memory card, and/or the like. The memory 150 may be used for storing instructions executable by the processing unit 142 and data used, generated, or collected by the processing unit 142. For example, the memory 150 may store instructions of software, software systems, or software modules that are executable by the processing unit 142 for implementing some or all of the functionalities and/or embodiments of the procedures performed by an AP 102 described herein.

Each input/output component 152 enables interaction with a user or other devices in the communication system 100. Each input/output device 152 may comprise any suitable structure for providing information to or receiving information from a user and may be, for example, a speaker, a microphone, a keypad, a keyboard, a display, a touch screen, a network communication interface, and/or the like.

Herein, the STAs 112 may be any suitable wireless device that may join the communication system 100 via an AP 102 for wireless operation. In various embodiments, a STA 112 may be a wireless electronic device used by a human or user (such as a smartphone, a cellphone, a personal digital assistant (PDA), a laptop, a desktop computer, a tablet, a smart watch, a consumer electronics device, and/or the like). A STA 112 may alternatively be a wireless sensor, an Internet-of-things (IoT) device, a robot, a shopping cart, a vehicle, a smart TV, a smart appliance, a wireless transmit/receive unit (WTRU), a mobile station, or the like. Depending on the implementation, the STA 112 may be movable autonomously or under the direct or remote control of a human, or may be positioned at a fixed position.

In some embodiments, a STA 112 may be a multimode wireless electronic device capable of operation according to multiple radio access technologies and incorporate multiple transceivers necessary to support such.

In addition, some or all of the STAs 112 comprise functionality for communicating with different wireless devices and/or wireless networks via different wireless links using different wireless technologies and/or protocols. Instead of wireless communication (or in addition thereto), the STAs 112 may communicate via wired communication channels to other devices or switches (not shown), and to the Internet 106. For example, a plurality of STAs 112 (such as STAs 112 in proximity with each other) may communicate with each other directly via suitable wired or wireless sidelinks.

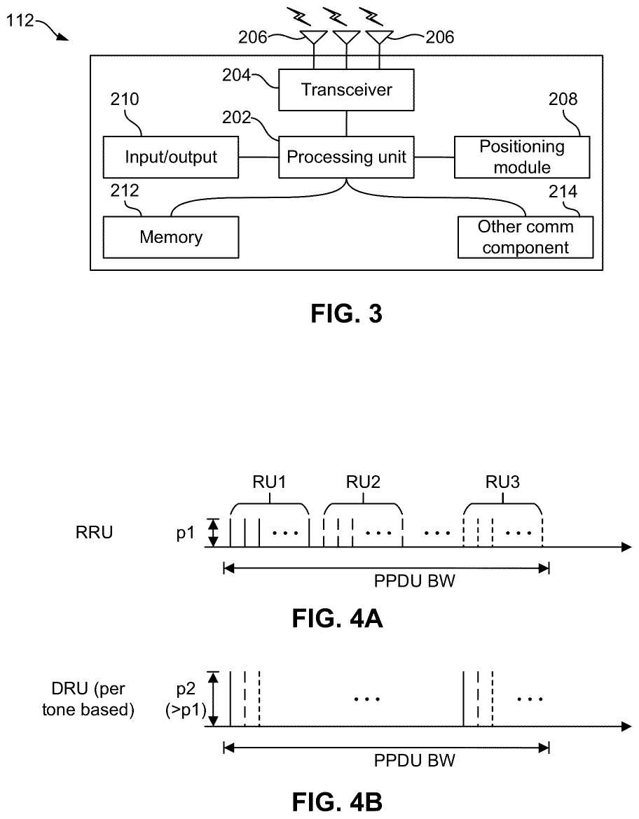

FIG. 3 is a simplified schematic diagram of a STA 112. As shown, the STA 112 comprises at least one processing unit 202, at least one transceiver 204, at least one antenna or network interface controller (NIC) 206, at least one positioning module 208, one or more input/output components 210, at least one memory 212, and at least one other communication component 214. Each of these components 202 to 214 may be implemented as one or more circuits (such as one or more electronic circuits and/or one or more optical circuits). Alternatively, the ensemble of these components 202 to 214 may be implemented as one or more circuits.

The processing unit 202 is configured for performing various processing operations such as signal coding, data processing, power control, input/output processing, or any other functionalities to enable the STA 112 to access and join the communication system 100 and operate therein. The processing unit 202 may also be configured to implement some or all of the functionalities of the STA 112 described in this disclosure. The processing unit 202 may comprise a central processing unit (CPU), a microprocessor, a microcontroller, a digital signal processor, an accelerator, a graphic processing unit (GPU), a tensor processing unit (TPU), a FPGA, or an ASIC. Examples of the processing unit 202 may be an ARM® microprocessor (ARM is a registered trademark of Arm Ltd., Cambridge, UK) manufactured by a variety of manufactures such as Qualcomm of San Diego, California, USA, under the ARM® architecture, an INTEL® microprocessor (INTEL is a registered trademark of Intel Corp., Santa Clara, CA, USA), an AMD® microprocessor (AMD is a registered trademark of Advanced Micro Devices Inc., Sunnyvale, CA, USA), and the like. In some embodiments, the processing unit 202 may execute computer-executable instructions or code stored in the memory 212 to perform various processes described below.

The at least one transceiver 204 may be configured for modulating data or other content for transmission by the at least one antenna 206 to communicate with an AP 102. The transceiver 204 is also configured for demodulating data or other content received by the at least one antenna 206. Each transceiver 204 may comprise any suitable structure for generating signals for wireless transmission and/or processing signals received wirelessly. Each antenna 206 may comprise any suitable structure for transmitting and/or receiving wireless signals. Although shown as a single functional unit, a transceiver 204 may be implemented separately as at least one transmitter and at least one receiver.

The positioning module 208 is configured for communicating with a plurality of global or regional positioning devices such as navigation satellites for determining the location of the STA 112. The navigation satellites may be satellites of a global navigation satellite system (GNSS) such as the Global Positioning System (GPS) of USA, Globa“naya Navigatsionnaya Sputnikovaya Sistema (GLONASS) of Russia, the Galileo positioning system of the European Union, and/or the Beidou system of China. The navigation satellites may also be satellites of a regional navigation satellite system (RNSS) such as the Indian Regional Navigation Satellite System (IRNSS) of India, the Quasi-Zenith Satellite System (QZSS) of Japan, or the like. In some other embodiments, the positioning module 208 may be configured for communicating with a plurality of indoor positioning device for determining the location of the STA 112.

The one or more input/output components 210 is configured for interaction with a user or other devices in the communication system 100. Each input/output component 210 may comprise any suitable structure for providing information to or receiving information from a user and may be, for example, a speaker, a microphone, a keypad, a keyboard, a display, a touch screen, and/or the like.

The at least one memory 212 is configured for storing instructions executable by the processing unit 202 and data used, generated, or collected by the processing unit 202. For example, the memory 212 may store instructions of software, software systems, or software modules that are executable by the processing unit 202 for implementing some or all of the functionalities and/or embodiments of the STA 112 described herein. Each memory 212 may comprise any suitable volatile and/or non-volatile storage and retrieval components such as RAM, ROM, hard disk, optical disc, SIM card, solid-state memory modules, memory stick, SD memory card, and/or the like.

The at least one other communication component 214 is configured for communicating with other devices such as other STAs 112 via other communication means such as a radio link, a BLUETOOTH® link (BLUETOOTH is a registered trademark of Bluetooth Sig Inc., Kirkland, WA, USA), a wired sidelink, and/or the like. Examples of the wired sidelink may be a USB cable, a network cable, a parallel cable, a serial cable, and/or the like.

In some embodiments, a STA 112 may comprise a plurality of transceivers 204 and a plurality of antennas 206 for communication with an AP 102.

In the communication between the AP 102 and the STA 112, a transmission from the STA 112 to the AP 102 is usually denoted an uplink (UL) and the wireless channel used therefor is denoted an uplink channel. A transmission from the AP 102 to the STA 112 is usually denoted a downlink (DL) and the wireless channel used therefor is denoted a downlink channel. Suitable modulation technologies may be used for communication between the AP 102 and the STA 112. For example, in some embodiments, orthogonal frequency-division multiplexing (OFDM) may be used wherein the channel 114 is partitioned into a plurality orthogonal subchannels for communication between the AP 102 and the STA 112. Moreover, as there are usually a plurality of STAs 112 in communication with a same AP 102, suitable multiple-access technologies may be used. For example, in some embodiments, orthogonal frequency-division multiple access (OFDMA) may be used for communication between the AP 102 and STAs 112.

### B. Orthogonal Frequency Division Multiple Access and Resource Units

### B-1. Resource Units, Tone Distributions and Hybrid PPDU

Some wireless communication systems such as IEEE 802.11ax (WI-FI® 6) systems use OFDMA for multiple access. Generally, OFDMA uses orthogonal frequency division multiplexing (OFDM) for multiple users to transmit data at the same time.

For example, in an IEEE 802.11ax system, a device such as an AP 102 or a STA 112 transmits data using physical layer protocol data units (PPDUs). A PPDU contains a preamble and a data field containing an OFDM symbol. As those skilled in the art understand, an OFDM symbol combines data elements into a plurality of subcarriers (also called “tones”) and uses the so-called cyclic prefix for combating inter-symbol interferences. The number of tones in an OFDM symbol depends on the bandwidth (BW) thereof. In IEEE 802.11ax, the subcarrier spacing is 78.125 kilohertz (kHz), and the OFDM BW (that is, the BW of OFDM symbols; also denoted “OFDMA BW” when OFDMA is used) may be 20 MHz, 40 MHz, or 80 MHz. Correspondingly, the number of OFDM tones (that is, the tones in an OFDM symbol; also denoted “OFDMA tones” hereinafter when OFDMA is used) may be 256, 512, or 1024. Some of these tones are unused, including direct-current (DC) tones (also called direct-conversion tones, which include the tone whose frequency is equal to the RF carrier frequency, and some neighboring tones thereof), guard tones, and null tones. Therefore, the usable tones are generally a subset of the total OFDM tones.

When OFDMA is used, the usable OFDMA tones or subcarriers are partitioned into a plurality of resource units (RUs) for assigning to a plurality of users for data and pilot transmission. In an OFDMA transmission, each RU in a PPDU is assigned to a specific STA so that multiple STAs data can be multiplexed within a single PPDU.

In a PPDU, consecutive-tone RUs (denoted “regular RUs” or “RRUs” hereinafter) have been used, wherein each RU consists of a plurality of consecutive tones. The smallest number of tones of an RU is 26 tones which forms the base RU size and the bigger size of RU has been built up based on the 26-tone RU.

In the 6 GHz low power indoor (LPI) bands, regulatory bodies such as Federal Communications Commission (FCC) apply stringent rules on the limit of maximum Equivalent isotropic radiated power (EIRP) power spectral density (PSD), for example, −1 decibel-milliwatts per megahertz (dBm/MHz) for non-AP STA 112. This limits the transmission range and/or reduces transmission rates.

Distributed resource units (DRU) (see IEEE 802.11-23-0037r0) may also be used to distribute tones of a user in an OFDMA system across a wide portion of spectrum within the PPDU bandwidth. In other words, the concept of DRU is to distribute the contiguously allocated data/pilot tones in a RRU (currently specified in 802.11) over a broader spectrum shared with other RUs. Therefore, a separation of data/pilot tones in DRU is required to be a multiple of subcarrier spacing specified in 802.11ax/be and the transmit power of each distributed tone in a DRU can be boosted under the regulation on the output PSD. More specifically, by using DRU, the number of tones of one user within one (1) MHz is reduced and the transmit power can be boosted, which may increase the transmit distance and/or improve the reliability for the STAs operating in the LPI bands.

FIGS. 4A and 4B illustrate the RRUs (FIG. 4A) and the DRUs (FIG. 4B) in the BW of a PPDU. The transmit power p2 of each tone in DRUs may be allowed to be greater than the transmit power p1 of each tone in RRUs because of the tone distribution.

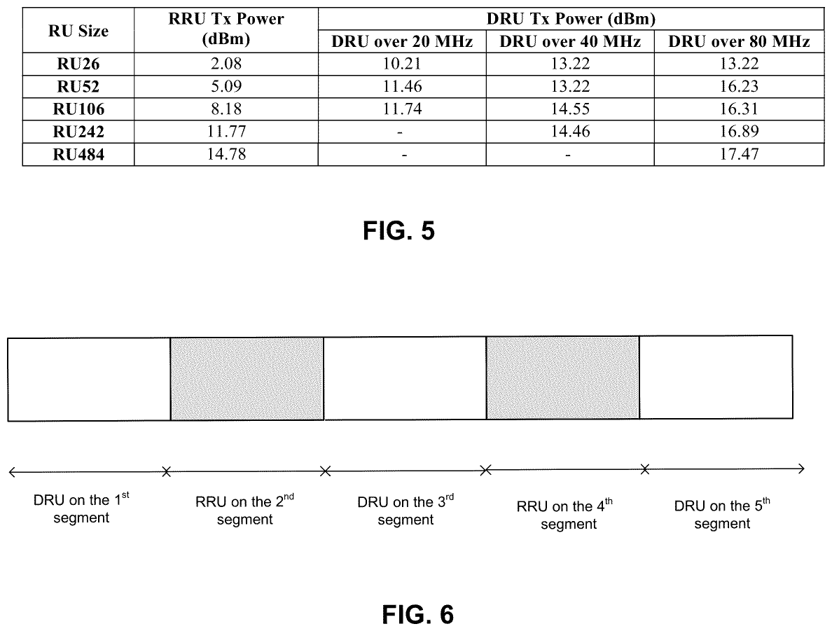

FIG. 5 presents the total TX power (in decibel-milliwatts per megahertz (dBm)) for RRU and DRU over different BWs. As can be seen in FIG. 5, the total TX power can be much larger when using DRUs compared with using RRUs of the same RU size. The wider the BWs of the DRUs (the BW of the DRU referring to the BW from the lowest-frequency tone of the DRU to the highest-frequency tone thereof), the larger the total TX power can be.

Although the transmit power can be boosted using DRUs, which may in turn increase the transmit distance and/or improve reliability for the STAs operating in the LPI bands, it is important to support transmission of a hybrid PPDU employing mixed DRUs and RRUs.

Mixed DRUs and RRUs refer to using both DRUs and RRUs at the same time for a PPDU transmission. Mixed DRU and RRU in a PPDU is currently considered for UL transmissions from STAs to an AP, but can be expanded to DL transmissions from the AP to the STAs. A PPDU including mixed DRUs and RRUs can be referred to as a hybrid PPDU.

In the 6 GHz band, a wide BW spectrum may span across different power mode regions with standard power (SP)/automated frequency coordination (AFC) in one region and LPI in another. Accordingly, a user or STA may be using RRU on one frequency segment, and another user or STA may be using DRU to boost power on another frequency segment. In such applications, it is important to support hybrid PPDU designs to achieve higher throughput and better spectral efficiency. Moreover, both DRU capable and incapable STAs can be supported at the same time in a mixed DRU & RRU PPDU transmission. FIG. 6 shows a hybrid PPDU with mixed RRU and DRU segments. In this example, the hybrid PPDU comprises three (3) DRU segments and two (2) RRU segments.

### B-2. Tone Distribution

In some embodiments, the communication system 100 uses OFDMA (denoted a “OFDMA system”) for multiple access, and uses a tone distribution method with a substantially uniform (or nearly uniform) tone separation for maintaining same performance across different users.

More specifically, in these embodiments, the tones of a DRU for a STA 112 (including data tones and pilot tones) are substantially uniformly (or nearly uniformly, or as uniformly as possible) distributed over the BW of the DRU, so as to maximize the per tone power based on the regulatory bodies' PSD limitation rules. Because BW of a DRU refers to the BW from the lowest-frequency tone of the DRU to the highest-frequency tone thereof, each DRU can share its BW with one or more other DRUs.

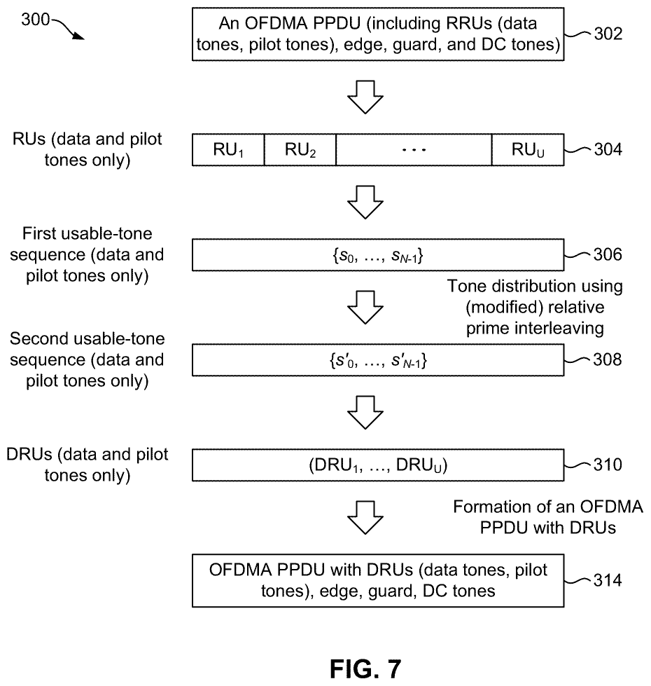

FIG. 7 is a flowchart showing a procedure 300 of designing or otherwise obtaining DRUs in an OFDMA PPDU with substantially uniform tone distribution using (modified) relative prime interleaving.

As described above, the tones of the OFDMA PPDU 302 may be classified as various types of tones based on the usage thereof, including usable tones (such as tones for transmitting data symbols (denoted “data tones”), tones for transmitting pilot symbols (denoted “pilot tones”), and/or the like) and unusable tones (such as edge tones, guard tones, DC tones, and/or the like).

The usable tones of the OFDMA PPDU 302 have been partitioned into U RUs 304, with the j-th RU, denoted RUⱼ (j=1, . . . , U) having Nⱼ usable tones for STAⱼ. For example, the U RUs 304 may be obtained in accordance with any existing tone plan specified in relevant standards, depending on the BW of the PPDU 302.

Then, a first usable-tone sequence 306 is obtained by concatenating the U RUs. The length of the first usable-tone sequence 306 is

$$N = {\sum }_{j = 1}^{U} {N}_{j} .$$

The first usable-tone sequence 306 is then interleaved, shuffled, or otherwise reordered by using a suitable interleaver (or a suitable interleaving method) to generate a second usable-tone sequence 308 (also denoted a “shuffled usable-tone sequence”).

Interleavers have been widely used in other fields of communication systems, wherein an interleaver reorders a sequence of symbols in a one-to-one mapping manner. For example, the relative prime interleavers (also called “relative prime interleaving”), which have been used in turbo coding in 3GPP LTE cellular systems, are proven practical interleavers with good symbol-spreading properties and ease of implementation.

A relative prime interleaver interleaves, shuffles, or otherwise reorders the symbols in a length-N input sequence {sₙ}(n=0, . . . , N−1) to obtain an output sequence

$$\{ {s}_{l}^{′} \} = \{ {s}_{k ( n )}^{′} \}$$

with a specific distance or spacing over a Galois field of size N (denoted GF (N)), wherein the relationship between the index n of the input sequence and the index l of the output, interleaved sequence is:

$$l = k ( n ) = ( p \cdot n ) mod N \qquad ( 1 )$$

for n=0, . . . , N−1, where “x mod y” represents the modulo function calculating the remainder of x divided by y, p is a parameter and is a relative prime with N (that is, p and N have no common factors other than one (1)), and

$${s}_{l}^{′} = {s}_{k ( n )}^{′}$$

for n=0, . . . , N−1. Thus, the interleaved sequence

$$\{ {s}_{l}^{′} \} = \{ {s}_{k ( 0 )} , … , {s}_{k ( N - 1 )} \} .$$

In these embodiments, a relative prime interleaver is used to interleave, shuffle, or otherwise reorder the first usable-tone sequence 306, with N being the total number of usable tones and

$$N = {\sum }_{j = 1}^{U} {N}_{j} ,$$

and p being the tone separation in each DRU, that is, p is the distance or spacing between neighboring tones in each DRU. A second usable-tone sequence 308 is then obtained.

The second usable-tone sequence 308 is partitioned into J DRUs 310 with the length of each DRU 310 being the same as the length of the corresponding RU 304. In other words, length (DRUⱼ)=length (RUⱼ)=Nⱼ, (j=1, . . . , U), where length(x) representing the length of x, and DRUⱼ represents the j-th DRU.

After the J DRUs 310 are obtained, the unusable tones such as the edge tones, guard tones and DC tones are inserted into the OFDMA PPDU based on the desired subcarrier and resource allocation in the PPDU (for example, at their original locations), thereby obtaining an OFDMA PPDU 314 with U DRUs. The obtained PPDU 310 then comprises U DRUs 310 having tones separated as uniformly as possible.

While this embodiment illustrates a tone distribution method based on (modified) relative prime interleaving, it should be understood that other tone distribution methods or approaches may be used to design or otherwise obtain the DRUs in an OFDMA PPDU.

As can be seen from the procedure according to FIG. 7, all RUs (j=1, . . . , U) in the OFDMA PPDU are used for tone distribution as DRUs. However, it may be necessary in many applications to maintain or designate a number of RUs in the PPDU as regular RUs (with consecutive tones), while distribute tones in other RUs which can be used as DRUs (i.e., DRU designated or capable RUs).

Various methods for designing a hybrid PPDU are proposed. Preferably, the design method of a hybrid PPDU is flexible for different DRU and RRU sizes (in terms of the total number of tones of each DRU and RRU) and different PPDU BWs. Practical implementation and simple signaling for tone distribution are also desirable.

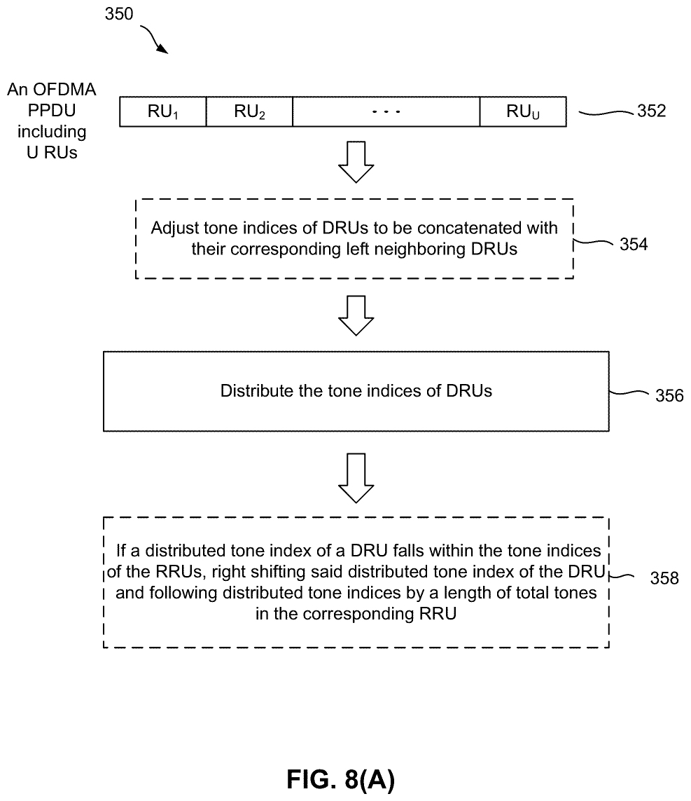

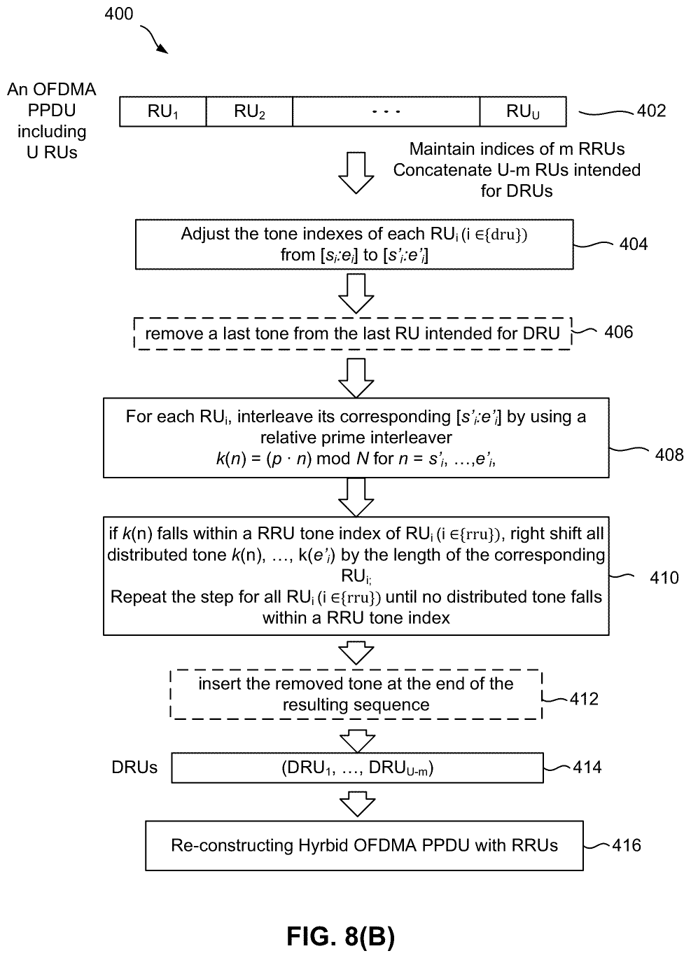

FIG. 8(A) is a flowchart showing a tone design procedure 350 for obtaining a hybrid PPDU with mixed DRUs and RRUs, according to some embodiments of this disclosure. More specifically, a hybrid PPDU can be obtained based on applying a tone distribution method (such as a relative prime interleaving method) to the DRUs (designated DRUs or DRUs capable RUs), while taking into consideration the effects of RRUs (designated RRUs or DRU incapable RUs) on the tone design.

Referring to FIG. 8(A), the usable tones of the OFDMA PPDU have been partitioned into U RUs 352. For example, the OFDMA PPDU may be partitioned in accordance with any existing tone plan specified in relevant standards, depending on the BW of the PPDU. Each RU in the OFDMA PPDU designated for a specific STA can be either a RRU (designated RRU or DRU incapable RU) or a DRU (designated DRU or DRU capable RU).

For each DRU, the tone indices of the tones of the DRU may be adjusted 354 to be concatenated with their corresponding left neighboring DRU. As can be appreciated by those skilled in the art, the adjusted tone indices may be the same as the original indices of the RU, if no intervening RRUs exist between the DRUs and their corresponding left neighboring DRUs.

The tone indices (or adjusted tone indices) of the tones of the DRUs are reordered, distributed, or otherwise obtained 356 using a tone distribution method. While various embodiments describe a tone distribution method based on relative prime interleaving, it should be understood that other methods or approaches may be used to reorder, distribute or otherwise obtain the tones for the DRUs.

For each RRU, if a tone index reordered, distributed, or otherwise obtained from step 356 falls within a RRU tone index, the tone index reordered, distributed, or otherwise obtained from step 356 and following distributed tone indices of the DRUs can be right shifted 358 by a length of total tones in the corresponding designated RRU. The step 358 can be repeated for all RRUs until no distributed tone falls within a RRU tone index.

As can be appreciated by those skilled in the art, if no distributed tone index falls within a RRU tone index, the reordered, distributed, or otherwise obtained tone indices will remain the same for step 358.

FIG. 8(B) is a flowchart showing a tone design procedure 400 for obtaining a hybrid PPDU with mixed DRUs and RRUs using (modified) relative prime interleaving, according to some embodiments of this disclosure. More specifically, FIG. 8 can obtain a hybrid PPDU based on applying relative prime interleaver (or interleaving method) to the DRUs (designated DRUs or DRU capable RUs), while taking into consideration the effects of RRUs (designated RRUs or DRU incapable RUs) on the tone design.

With reference to FIG. 8(B), the usable tones of the OFDMA PPDU have been partitioned into U RUs 402. For example, the OFDMA PPDU may be partitioned in accordance with any existing tone plan specified in relevant standards, depending on the BW of the PPDU. Each RU in the OFDMA PPDU designated for a specific STA can be either a RRU (designated RRU or DRU incapable RU) or a DRU (designated DRU or DRU capable RU).

The U RUs 402 therefore comprises two sets, a first set including U-m designated DRUs or DRU capable RUs (collectively referred to as DRUs) and a second set including m designated RRUs or DRU incapable RUs (collectively referred to as RRUs). Amongst the U RUs 402, the unit indices for the m RRUs form a subset rru; and the unit indices for the U-m DRUs form a subset dru.

As described above, the unusable tones of the OFDMA PPDU (such as edge tones, guard tones, DC tones, and/or the like) may be removed. For ease of illustration, unusable tones are not shown.

Each RU is denoted as RUᵢ (i=1, . . . , U), which has Nᵢ usable tones for STAᵢ. [sᵢ:eᵢ] represents the tone index of the RUᵢ, where sᵢ is a starting tone index of RUᵢ and eᵢ is an ending tone index of RUᵢ, and Nᵢ=eᵢ−sᵢ+1.

According to the embodiment, the tone indices of the m RRUs (designated RRUs or DRU incapable RUs) are maintained, while tones in the U-m RUs intended for DRUs (designated DRUs or DRU capable RUs) are to be interleaved, shuffled, shifted or otherwise reordered.

For each of the U-m RUs intended for DRUs, the tone indices of RUᵢ (when i∈dru) can be left-shifted or adjusted 404 to remove the impact of the RRUs, so that the tone indices of each RUᵢ intended for DRUs (when i∈dru) can be concatenated with their corresponding left neighboring DRU. The adjusted tone indices are denoted as [s′ᵢ:e′ᵢ], where s′ᵢ is an adjusted starting tone index of RUᵢ and e′ᵢ is an adjusted ending tone index of RUᵢ. As can be appreciated by those skilled in the art, the adjusted tone indices may be the same as the original indices of the RU, if no intervening RRUs exist between the RUs intended for DRUs and their corresponding left neighboring DRU.

The resulting adjusted tone sequence is a consecutively indexed tone sequence with a length of Σᵢ Nᵢ (i∈dru) corresponding to a total number of tones in the U-m RUs intended for DRUs.

For each RUᵢ (when i∈dru), each tone in its corresponding [s′ᵢ:e′ᵢ] can be interleaved 408 by using a relative prime interleaver:

$$k ( n ) = ( p \cdot n ) mod N$$

where n=s′ᵢ, . . . , e′ᵢ, k is a function of n, mod represents a modulo function, N is a length of the sequence for the interleaving step 408 and can be determined based on the total number of tones in the U-m RUs intended for DRUs, p is a minimum distance between two neighboring tones in each RU intended for DRUs and is a relative prime of N such that p and N have no common factors other than one. The sequence for the interleaving step 408 can be referred to as the “intermediate sequence”.

If the tone index k(n), obtained from shuffling, interleaving or any other approach, falls within a RRU tone index of RUᵢ (i∈rru), all distributed tone k(n), . . . , k(e′ᵢ) are right shifted 410 by the length of the corresponding RUᵢ. The step 410 is repeated for all RUᵢ (i∈rru) until no distributed tone falls within a RRU tone index.

As can be appreciated by those skilled in the art, if no k(n) falls within a RRU tone index, the shuffled, interleaved or otherwise obtained tone indices will remain the same for step 410.

It should be understood that p is the tone separation in each DRU, that is, p is the distance or spacing between neighboring tones in each DRU and can be appropriately chosen so that it is a relative prime of N. Shortening tones may be removed or dummy tones may be added before the interleaving step 408 so that the total length of the intermediate sequence N for the interleaving step 408 and p have no common factors other than one.

According to some embodiments of this disclosure, a shortening tone (e.g., a last tone) can be removed from the last RU intended for DRUs so that N=ΣᵢNᵢ−1, i∈dru. p can be any relative prime of N such that p and N have no common factors other than one. In some embodiments, p is determined based on the structure (e.g., the partitioning) of RUs such that it is a relative prime of N. For example, if the sizes of the RUs intended for DRUs are equal, p can correspond to the total unit number of the RUs intended for DRUs. In other words, p=U−m.

According to some embodiments of this disclosure, the design method may further comprise removing 406 the last tone from the last RU intended for DRU before said shuffling. The last tone can be inserted 412 at the end of the resulting sequence after step 408 or step 410.

The resulting sequence is partitioned into U−m DRUs 414 with the length of each DRU being the same as the length of the corresponding RUᵢ (i∈dru) intended for DRU.

After the U−m DRUs are obtained, the OFDMA PPDU can be reconstructed with the m RRUs at their corresponding locations, thereby obtaining a hybrid OFDMA PPDU 416 with U RUs. The obtained hybrid OFDMA PPDU 416 can comprise m RRUs with consecutive tones and U−m DRUs with tones separated as uniformly as possible.

The unusable tones (not shown) such as the edge tones, guard tones and DC tones may also be inserted into the OFDMA PPDU at their original locations, or based on the desired subcarrier and resource allocation.

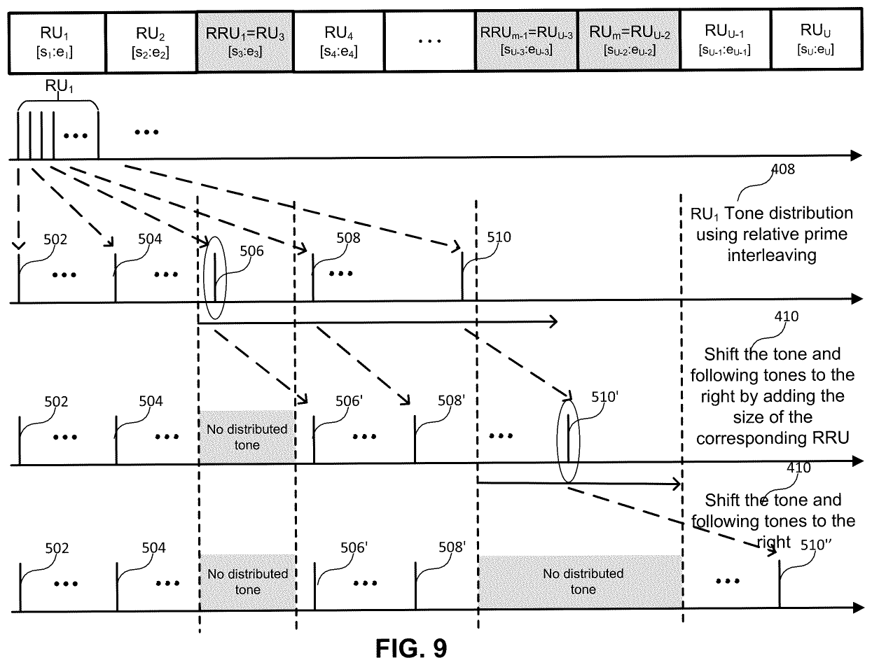

FIG. 9 is a schematic diagram applying the steps of the tone design procedure in FIG. 8(B) to an example hybrid PPDU with mixed DRUs and RRUs;

Similar to FIG. 8(B), assume an OFDMA PPDU includes U RUs available for U users. Among these U RUs, m of them are either DRU incapables RUs or designated regular RU (collectively referred to as RRUs), and U−m of them are DRU capable RUs or designated distributed RU (collectively referred to as DRUs). The tones within each RUᵢ are indexed by [sᵢ:eᵢ], where sᵢ is a starting tone index of RUᵢ and eᵢ is an ending tone index of RUᵢ. For example, the m RRUs in this example are RU₃, . . . , RU_{U-3}, and RU_{U-2}. The unit indices for the m RRUs form a subset rru={3, . . . , U−3, U−2}; and the unit indices for the U−m DRUs form a subset dru={1, 2, 4, . . . , U−1, U}.

For each RUᵢ (i∈dru) intended for DRU, the tones of the DRUs can be interleaved, shuffled, or otherwise reordered 408 using (modified) relative prime interleaving as explained above. In the relative prime interleaver according to this example, parameter N may be equal to the total number of distributed tones minus one and the parameter p may be equal to the total number of DRUs, i.e., U−m. As shown in FIG. 9, the plurality of tones in RU₁ are interleaved to tones 502, 504, 506, 508, . . . , 510.

If the resulting tone, i.e., shuffled, interleaved or obtained tone, is located in an RRU (i.e., RUᵢ (i∈rru)), said interleaved tone and the following tones are right shifted 410 by adding the corresponding RUᵢ size to the tones. For example, because the obtained tone 506 falls within the tone index of RRU₁=RU₃, the obtained tone 506 and its following tones 508, . . . , 510 are right shifted by the size of RU₃, i.e., right shifted or added by e₃_s_{b 3}+1, to tones 506′, 508′, . . . , 510′.

The step 410 is repeated for all RUᵢ (i∈rru) until no distributed tone falls within a RRU tone index. Because the right shifted tone 510′ falls within RRUₘ₋₁=RU_{U-3}, tone 510′ (in this case tone 510′ is the last tone for RU₁) is again right shifted, by the size of RU_{U-3}, i.e., right shifted or added by e_{U-3}−s_{U-3}+1, to tone 510″.

The resulting tones for DRU₁=RU₁ after distribution and right shifting are therefore 502, 504, 506′, 508′, . . . , 510″.

According to one embodiment of this disclosure, the algorithm for tone design in a hybrid PPDU can be provided as follows:
Set the number of RUs, U, and their corresponding starting and ending indices, i.e., sᵢ and eᵢ. Set rru as the subset of unit indices of RUs designated as RRUs. Set the length of the intermediate sequence, N, and prime relative parameter, p. j=0. shift_left=0

```
for u=1:U do
  if u ∈ rru then
    shift_left += eᵤ− sᵤ +1
  else
    shift_right = 0; j++;
    for t= sᵤ−shift_left : eᵤ− shift_left do
      dt= (t==N) ? N + shift_right : mod(p·t, N) + shift_right;
      for i in rru do
          if sᵢ≤ dt ≤ eᵢ then
            shift _right += eᵢ−sᵢ+1; dt+= shift _right;
        end if
        end for
        append dt to DRUⱼ
      end for
  end for
```

As described above, N can be determined based on the total number of tones in the U-m RUs intended for DRUs, p is a minimum distance between two neighboring tones in each RU intended for DRUs and can be any suitable relative prime of N such that p and N have no common factors other than one.

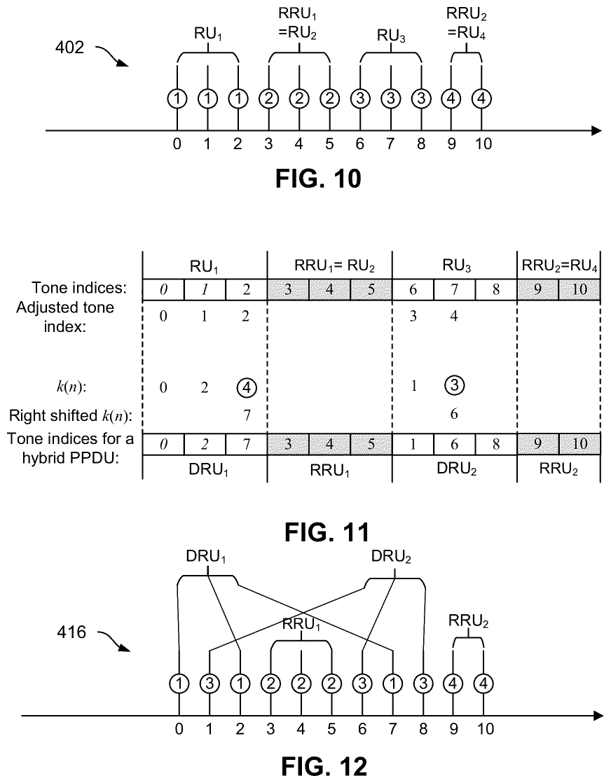

FIGS. 10 to 12 show an example (for illustrative purposes only, and may not be a real scenario) for applying the tone design procedure as shown in FIG. 8(B). As shown, an OFDMA PPDU 402 has partitioned into U=4 RUs, RU₁ to RU₄, including two (2) RUs designated for RRUs, and two (2) RUs designated for DRUs. Here, RRU₁=RU₂, RRU₂=RU₄. rru={2, 4}; and dru={1, 3}.

The four (4) RUs have tone indices of {0, 1, 2, 3, 4, 5, 6, 7, 8, 9, 10}. In particular, the tone indices for RU₁ to RU₄ are [0:2], [3:5], [6:8], [9:10], respectively.

As shown in FIG. 8(B), the tone indices of RUᵢ intended for DRUs (i∈dru) are left shifted or adjusted 404 so that they are concatenated with their corresponding left neighboring DRUs. For example, tone indices of RU₃ are adjusted from [6:8] to [3:5], removing the effect of the intervening RRU₁=RU₂.

At step 406, a shortening tone (e.g., a last tone) may be removed from the last RU intended for DRU. For example, the last tone for RU₃ can be removed.

The adjusted tone indices are input to the relative prime interleaver to obtain k(n) where n=0, 1, 2, 3, 4 (step 408). Thus, the interleaved sequence k(n) is {0, 2, 4, 1, 3}. The total length of the interleaving sequence N may be equal to the total number of distributed tones minus one and the parameter p may be equal to the total number of DRUs as the sizes of DRUs are equal. In this case, N=5 and p=2.

At step 410, because the shuffled, interleaved or otherwise obtained tone k(2)=4 is located in RRU₁=RU₂, the shuffled, interleaved or otherwise obtained tone k(2) is right shifted by adding the corresponding RU₂ size to the tone index. Therefore, the right shifted tone index for k(2) is k(2)+3=7. Similarly, because the shuffled, interleaved or otherwise obtained tone k(4)=3 is located in RRU₁=RU₂, the interleaved tone k(4) is right shifted by adding the corresponding RU₂ size to the tone index. Therefore, the right shifted tone index for k(4) is k(4)+3=6.

At step 412, the shortening tone (e.g., the last tone) may be inserted back to the last RU intended for DRU. For example, the last tone for RU₃ is inserted back, indexed as 8.

At step 414, the two (2) DRUs are obtained as: DRU₁={0, 2, 7}, DRU₂={1, 6, 8}.

At step 416, the OFDMA PPDU can be reconstructed with RRUs, so the tone indices for a hybrid PPDU are {0, 2, 7, 3, 4, 5, 1, 6, 8, 9, 10}.

The reconstructed sequence can be reordered in accordance with n=0, . . . , 10. The reordered sequence is shown in FIG. 12, wherein the circled numbers represent the RU unit indices.

As can be seen in the example, the tone design procedure maintains the consecutive tone indices of the RRUs while uniformly (or nearly uniformly) distributing tones in the DRUs.

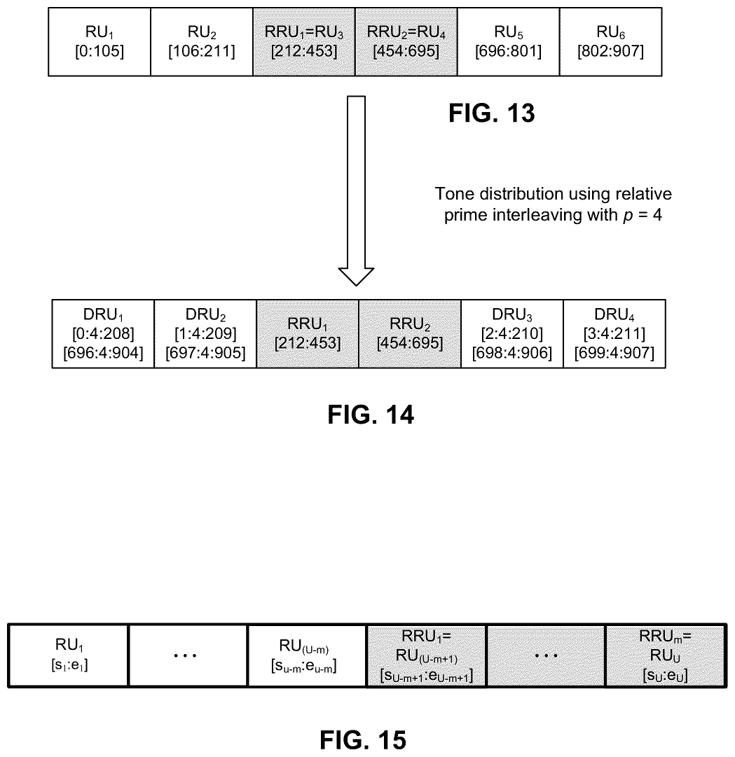

FIG. 13 is a schematic diagram showing an example of an 80 MHz hybrid OFDMA PPDU.

In this example, the hybrid OFDMA PPDU includes four (4) RUs intended for DRUs and two (2) RUs intended for RRUs, rru={3, 4}, and dru={1, 2, 5, 6}. In particular, the OFDMA PPDU comprises total 4×106-tone DRUs and 2×242-tone RRU.

The tone indices of the six (6) RUs are: RU₁: [0:105], RU₂: [106:211], RU₃: [212:453], RU₄: [454:695], RU₅: [696:801], and RU₆: [802:907], respectively.

FIG. 14 shows the hybrid PPDU after applying the tone distribution procedure where the tones for the RUs intended for DRUs are shuffled using a relative prime interleaver with a tone separation p=4.

In accordance with this embodiment, an intermediate tone sequence can be considered as a concatenation of four (4) RUs not considered for RRUs (dru={1, 2, 5, 6}) minus one shortening tone (i.e., the last tone). The length of the intermediate sequence is N=4×106−1=423. The minimum tone separation p in the interleaving can be 4. The interleaved tones can be shifted or otherwise arranged to create the DRUs and the shortening tone can be added to the last DRU.

The resulting tone indices of the four (4) RUs intended for DRUs are generated as:
DRU₁: [0:4:208], [696:4:904]
DRU₂: [1:4:209], [697:4:905]
DRU₃: [2:4:210], [698:4:906]
DRU₄: [3:4:211], [699:4:907]

The notation “[a:b:c]” refers to numbers starting from a to c with an incremental step of b (that is, the numbers of a, a+b, a+2b, . . . , c). When b is omitted, the default of b is 1. As can be seen from the resulting tone sequence, the tones in each DRU may be distributed with desired tone separations while the tones in each RRU remain consecutive.

In some embodiments of this disclosure, all m RRUs are allocated at the end of the hybrid OFDMA PPDU, as shown in FIG. 15. In other words, all RRUs are allocated to the right side of RUs intended for DRU in the hybrid OFDMA PPDU.

By moving RRUs to the end of the hybrid PPDU, the complexity and overhead can be reduced. DRUs are arranged continuously in the hybrid OFDMA PPDU and therefore the corresponding tones can be more evenly or close to evenly distributed, making the channel smoother and optimization easier. Using this approach, shift_left and shift_right parameters in the algorithm described above can be zero all the time, thereby simplifying the tone distribution procedure.

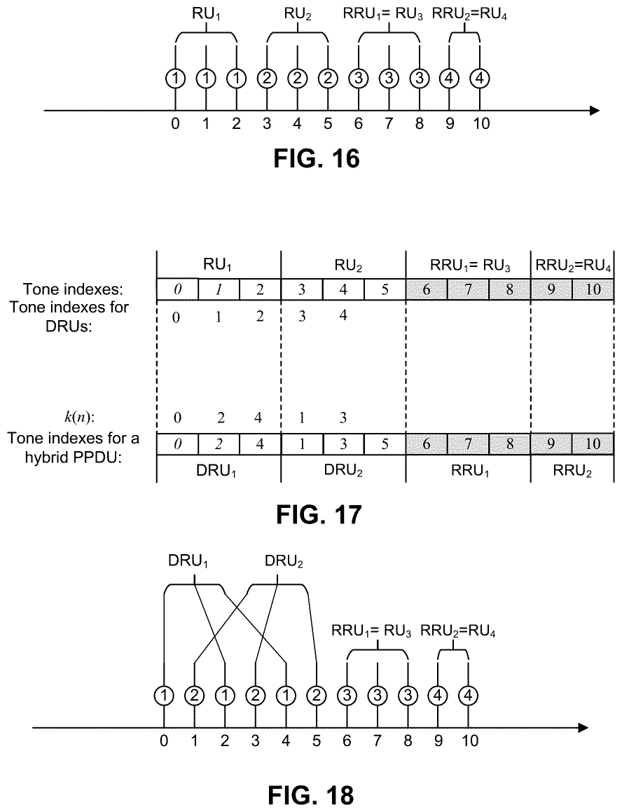

FIGS. 16 to 18 show an example (for illustrative purposes only, and may not be a real scenario) for applying the tone design procedure according to such embodiments. As shown, the OFDMA PPDU has all two (2) RRUs allocated at the end of the hybrid OFDMA PPDU. Here, RRU₁=RU₃, RRU₂=RU₄; rru={3, 4}, and dru={1, 2}.

Because all RRUs are arranged after the DRUs, the tone indices for the DRUs do not need to be shifted or adjusted as they are already concatenated with their corresponding left neighboring DRUs. Therefore step 404 can be omitted.

At step 406, a shortening tone (i.e., the last tone) may be removed from the last RU intended for DRU. For example, the last tone for RU₂ can be removed.

The tone indices for the DRUs are input to the relative prime interleaver or using other tone distribution methods to obtain k(n) (n=0, 1, 2, 3, 4) (step 408). In the case of the relative prime interleaver, the obtained sequence is {0, 2, 4, 1, 3}. The total length of the interleaving sequence N may be equal to the total number of distributed tones minus one and the parameter p may be equal to the total number of DRUs. In this case, N=5 and p=2.

Because all RRUs are arranged after the DRUs, the obtained tone indices for the DRUs do not need to be shifted or adjusted. Therefore step 410 can be omitted.

At step 412, the shortening tone (i.e., the last tone) may be inserted back to the last RU intended for DRU. For example, the last tone for RU₂ is inserted back, indexed as 5.

At step 414, the two (2) DRUs are obtained as: DRU₁={0, 2, 4}, DRU₂={1, 3, 5}.

At step 416, the OFDMA PPDU can be reconstructed with RRUs, so the tone indices for the hybrid PPDU are {0, 2, 4, 1, 3, 5, 6, 7, 8, 9, 10}. The reconstructed sequence can be reordered, as shown in FIG. 18, wherein the circled numbers represent the RU unit indices.

In the above embodiments, the tone distribution methods (using e.g., relative prime interleavers) for a hybrid PPDU including mixed RRUs and DRUs are described. The tone distribution methods disclosed herein may be used to generate RRUs and DRUs of suitable sizes and can apply to various sizes of PPDU. For example, the tone distribution methods disclosed herein can be applied to a hybrid OFDMA PPDU with BWs of 20 MHz, 40 MHz, 80 MHZ, 160 MHz, and/or 320 MHz. Using the tone distribution methods as described above, a hybrid PPDU can be designed for special cases such as 20 MHz puncturing and 20 MHz operating STAs.

The tone distribution methods disclosed herein generally use a relative prime interleaver or other tone distribution methods to interleave, shuffle, or otherwise reorder the indices of the usable tones of the RUs intended for DRUs in a PPDU (wherein the indices of the usable tones of the RUs may be different to the indices of the usable tones in the PPDU which include other various unusable tones).

The relative prime interleaver requires that the tone separation p be a relative prime of the length N of the intermediate sequence (i.e., the sequence input to the interleaving step 408). While the embodiments described above remove the last tone from a last RU intended for DRU as a shortening tone, those skilled in the art can appreciate that the methods can apply to other sequence modification. For example, in some embodiments sequence padding (that is, adding some dummy tones) or sequence shortening (that is, removing some tones) may be used to adjust the length N of the intermediate sequence to make N a relative prime of p. After interleaving, the dummy tones (if sequence padding is used) are removed from interleaved, shuffled, or otherwise reordered usable-tone sequence, or the removed tones (if sequence shortening is used) are added back to the interleaved, shuffled, or otherwise reordered sequence.

The usable-tone sequence is then partitioned into a plurality of DRUs. In some embodiments, the partitioning of the DRUs may reference to a corresponding RU plan (that is, an RU plan having the same number of RUs as the number of DRUs, and the sizes of the RUs are the same as those of the DRUs, although the tones in each RU are different to the tones in the corresponding DRU).

As described above, in some embodiments, the partitioning of the DRUs may be performed based on the requirements (such as the number of DRUs, or numbers of DRUs of different sizes), and without referencing to any RU plan.

In some embodiments, a tone distribution sequence determined as described above may be stored as a table in both an AP 102 and an STA 112 such as storing in one non-transitory computer-readable storage device or media thereof. Then, the AP 102 and STA 112 may find for data and/or pilot transmission therebetween by looking up the table.

In some embodiments, instead of using a table, the AP 102 and STA 112 may calculate “on-the-fly” the tone distribution sequence as described above, and select an RU for data and/or pilot transmission therebetween.

### C. Signaling for a Hybrid PPDU

Some wireless communication systems such as IEEE 802.11ax (WI-FI® 6) systems specify the formats of signaling between APs and STAs for purposes of the OFDMA PPDU transmission. For example, in a DL transmission, an AP can transmit to one or more STAs a signal containing resource allocation information of the PPDU so that each user or STA can determine the RU allocated for the user for transmission using the RU.

RU allocation information is communicated to the users at both the physical (PHY) and Medium Access Control (MAC) layers. At the PHY layer, RU allocation information can be found in the SIG field in the preamble (or header) of an OFDMA PPDU signal transmitted from an AP. For example, this signal can be a multi-user (MU) PPDU signal. As specified in Wi-Fi 6/IEEE 802.11ax, RU allocation information can be found in a “HE-SIG-B” field in the PHY header of a “HE MU PPDU” signal. The SIG field (e.g., “HE-SIG-B” field) is used to communicate RU assignments (e.g., RU sizes and/or frequency allocations) to the users. For example, in a DL transmission, the “HE MU PPDU” signal carrying a mixture of 26-, 52-, 106-, 242-, 484-, and 996-tone RUs can be transmitted from an AP to various STAs. The SIG field (e.g., the “HE-SIG-B” field) in the signal can specify the corresponding RU assignments, including the number and sizes of RUs in the PPDU.

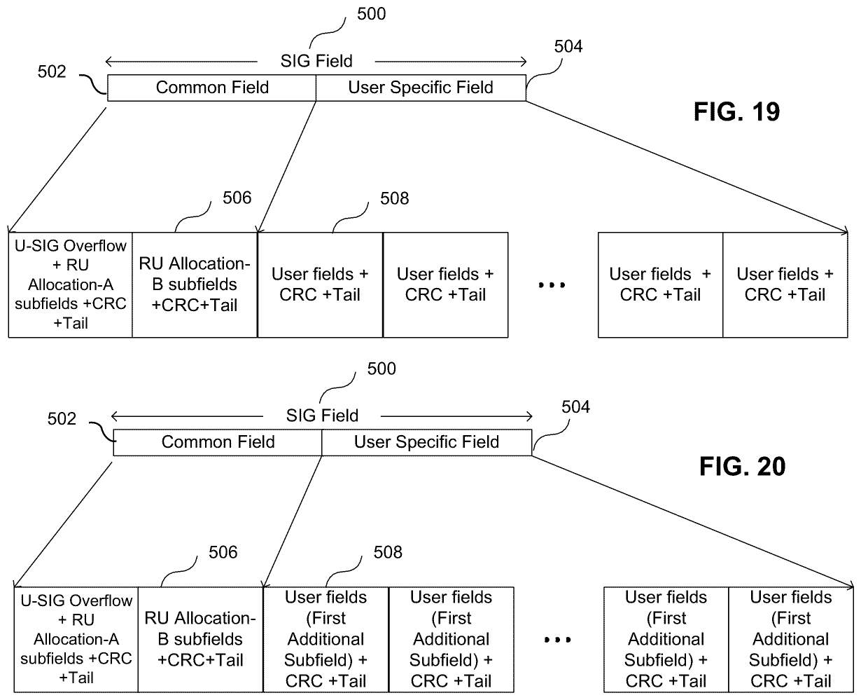

FIG. 19 is a schematic diagram showing the SIG field 500 of a PHY layer OFDMA PPDU signal. As shown in FIG. 19, the SIG field 500 comprises two fields: a “Common Field” (or “Common Info Field”) 502 and a “User Specific Field” (“User field”, or “User Info Field”) 504.

The Common Field 502 can comprise at least one RU allocation subfield 506 for providing information on the number and sizes of the plurality of RUs in the PPDU. The number of the RU allocation subfields 506 can depend on the BW of the PPDU, where each RU allocation subfield 506 can correspond to a subchannel of the PPDU and indicate how a subchannel is partitioned into various RUs. Currently, each RU allocation subfield 506 can correspond to a 20 MHz frequency subchannel. For example, one RU allocation subfield 506 can indicate that a corresponding 20 MHz subchannel is subdivided into one 106-tone RU and four 26-tone RUs.

The User Specific Field 504 comprises multiple user fields 508 relating to multiple RUs, each designated for a user at a STA. The user fields 508 are used to communicate how the users are assigned to the RUs. For example, each user field 508 can contain user information of a corresponding RU allocated for the user.

Each of the subfields 506, 508 may also include other information including but not limited to a cyclic redundancy check (CRC) subfield indicating the value of CRC and a tail subfield for indicating the value of tail bits. The common field 502 may further include a U-SIG overflow subfield.

As described above, a hybrid PPDU or mixed DRU & RRU, where DRUs and RRUs are used at the same time for a PPDU transmission, can achieve higher throughput and better spectral efficiency. Moreover, DRU incapable STAs can be accommodated using a hybrid OFDMA PPDU. By considering various hybrid PPDU sizes and diverse distribution bandwidths, the flexibility of the PPDU design can be significantly increased.

However, to transmit a signal using a hybrid PPDU, the STA or the user would need to obtain further information necessary to determine the RU assigned in the hybrid PPDU. For example, further signaling information may be needed to determine the locations of the RRUs or DRUs in the hybrid PPDU, and how the tones are distributed for the DRUs. For the user or STA to transmit a signal using the hybrid PPDU, the user or STA may require further signaling information to determine the type of the RU assigned to the STA or user (e.g., whether the RU is a regular RU or a distributed RU), and/or how the tones are distributed if the allocated RU is a DRU. Such information can introduce overhead to the signaling used for transmission. A desired design for tone distribution in a hybrid PPDU can therefore improve the flexibility of RU designs and yet reduce the introduction of extra overhead in signaling.

According to various embodiments of this disclosure, the signaling method for a hybrid PPDU reuses the current RU allocation subfields. The current RU allocation subfields comprise one or more RU allocation subfields 506 in the Common Field 502 of the OFDMA PPDU signal for indicating a size of each of the plurality of RUs in the PPDU. The number of the RU allocation subfields 506 depends on the size of the PPDU. Currently, each RU allocation subfield can correspond to a 20 MHz frequency subchannel.

FIG. 20 is a schematic diagram showing a SIG field 500 in a preamble of a PHY layer PPDU signal, including a first additional subfield in each user field 508, according to some embodiments of this disclosure.

In accordance with such embodiments, each user field 508 in the User Specific Field 504 can include a first additional subfield for indicating whether a corresponding RU is a RRU or DRU. The first additional subfield is also referred to as the “DRU/RRU indication bit”. The first additional subfield can comprise one (1) bit corresponding to each allocated RU for indicating if the allocated RU is regular or distributed. The number of added bits corresponds to the number of RUs included in the hybrid PPDU.

With the first additional subfield indicating if each allocated RU in the PPDU is regular or distributed, the user can determine the locations of the corresponding RRUs and DRUs. When combined with the current RU allocation subfields which specify the sizes of each RU in the PPDU, the user can determine the intermediate interleaving sequence N as well as the minimum tone separation p in the case of using a tone distribution method based on a relative prime interleaver. In other words, parameters N and p for the interleaver as described with reference to FIG. 8(B) can be calculated using the current RU allocation subfields and the first additional subfield for each RU. For example, N can be determined based on the total number of tones in the DRUs, p can be any suitable relative prime of N such that p and N have no common factors other than one. In some implementations, p can be equal to the unit number of DRUs, for example, when the sizes of DRUs are equal.

Using this approach, a smaller number of additional bits may be used. However, to find N and p parameters for the interleaver, a user would need to decode all user fields 508 for all RUs in the OFDMA.

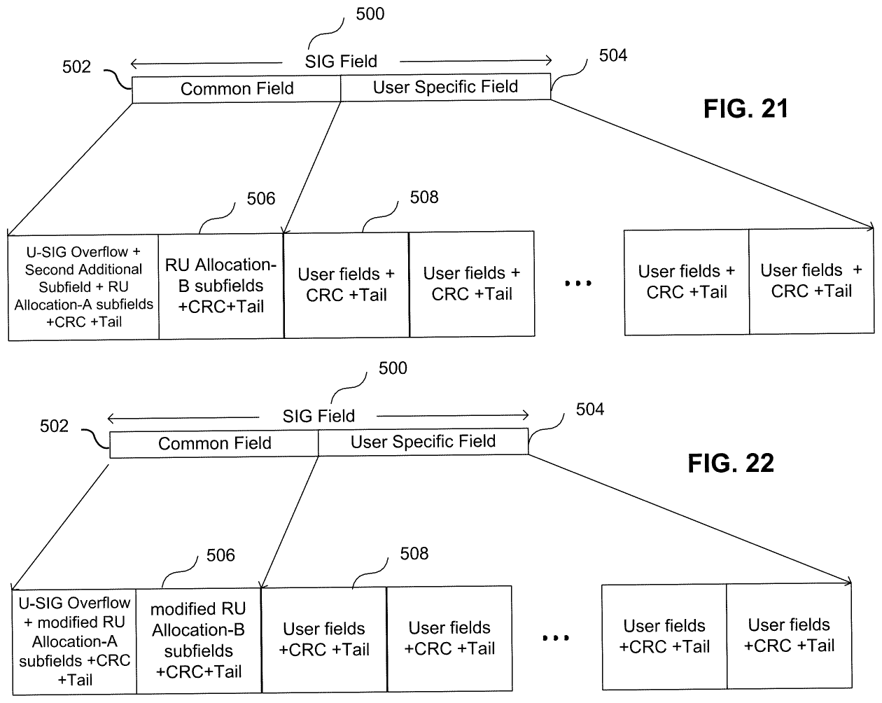

FIG. 21 is a schematic diagram showing the SIG field 500 in a preamble of a PHY layer OFDMA PPDU signal, including a second additional subfield in the Common Field 502, according to some embodiments of this disclosure.

In accordance with such embodiments, the Common Field 502 comprises a second additional subfield for indicating a total number of RRUs. For example, the second additional subfield can comprise up to eight (8) bits for indicating the number of RRUs. Such signaling method can apply to the tone distribution design as shown in the embodiments when the RRUs are located at the end of the PPDU, as shown in FIGS. 15-18.

Using this approach, a user does not need to decode the entire User Specific Field 504 to calculate N and p. Instead, parameters N and p for the interleaver can be calculated using information relating to the sizes of the RUs and the number of RRUs. For example, N can be determined based on the total number of tones in the DRUs, p can be any suitable relative prime of N such that p and N have no common factors other than one. In some implementations, p can be equal to the unit number of DRUs, for example, when the sizes of DRUs are equal.

FIG. 22 is a schematic diagram showing the SIG field 500 in a preamble of a PHY layer PPDU signal, including a modified RU allocation subfield, according to some embodiments of this disclosure.

As described above, each RU allocation subfield currently corresponds to a 20 MHz frequency subchannel. In accordance with such embodiments, 20 MHz minimum BW constraint is set for each RRU or DRU. In other words, RRUs and DRUs are not mixed within the same 20 MHz. In this case, a modified RU allocation subfield can comprise an additional 1 bit to indicate the use of RRU or DRU in the corresponding subchannel. Parameters N and p for the interleaver can be calculated using the modified RU allocation subfield including the additional bit. Using this approach, the signaling method can introduce less signaling overhead and reduce the complexity for decoding.

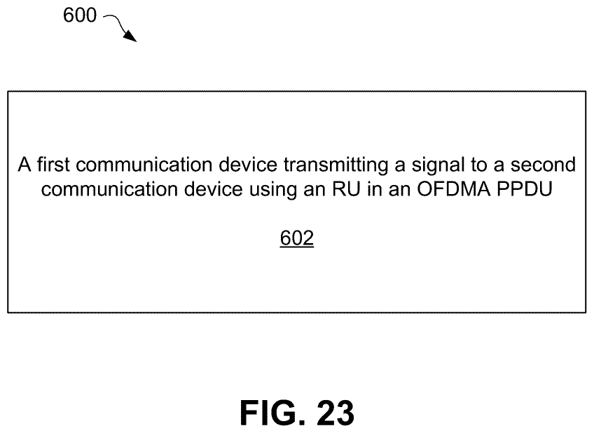

FIG. 23 is a flow chart of a first communication method (600) in accordance with some embodiments of the disclosure.

The first communication method (600) comprises a first communication device transmitting (602) a signal to a second communication device using an RU in an OFDMA PPDU. Each of the first and second communication devices can be an AP 102 or a STA 112.

The RU is one of a plurality of RUs of the OFDMA PPDU. The plurality of RUs comprises a first set (e.g., a set of DRUs) including at least one first RU (e.g., at least one DRU) and a second set (e.g., a set of RRUs) including at least one second RU (e.g., at least one RRU). Each first RU of the first set comprises a plurality of first subcarriers for data and/or pilot-symbol transmission and each second RU of the second set comprises a plurality of second subcarriers for data and/or pilot-symbol transmission.

The plurality of first subcarriers of each first RU of the first set are same subcarriers determined in accordance with a design method that distributes the first subcarriers, and the plurality of second subcarriers of each second RU of the second set are arranged consecutively. For example, the design method that distributes or shuffles the first subcarriers can be based on a relative prime interleaving method described with reference to FIG. 8(B).

According to some embodiments, for each first RU of the first set of the plurality of RUs, the first subcarrier indices of the first subcarriers of the first RU can be adjusted to be concatenated with a corresponding left neighboring first RU of the first set. The adjusted first subcarrier indices of the first subcarriers can then be shuffled according to the design method.

According to some embodiments, for each second RU of the second set of the plurality of RUs, if a distributed first subcarrier index falls within a second subcarrier index of the second set of the plurality of RUs, the distributed first subcarrier index and following distributed first subcarrier indices can be right shifted by a length of total second subcarriers in the corresponding second RU.

According to some embodiments, the design method can comprise:
for each first RUᵢ of the first set of the plurality of RUs, where i belongs to a unit index of the first set of the plurality of RUs:
adjusting [ₛi:eᵢ] to [s′ᵢ:e′ᵢ] to be concatenated with their corresponding left neighboring first RUs of the first set, where sᵢ is a starting first subcarrier index of RUᵢ, eᵢ is an ending first subcarrier index of RUᵢ, s′ᵢ is an adjusted starting first subcarrier index of RUᵢ, and e′ᵢ is an adjusted ending first subcarrier index of RUᵢ;
shuffling a first subcarrier index of each first subcarrier within [s′ᵢ:e′ᵢ] using

$$k ( n ) = ( p \cdot n ) mod N$$

where n=s′ᵢ, . . . , e′ᵢ, k is a function of n, mod represents a modulo function, N is determined based on a total number of first subcarriers in the first set of the plurality of RUs, p is a minimum distance between two neighboring first subcarriers in each RU of the first set of the plurality of RUs and is a relative prime of N such that p and N have no common factors other than one; and
for each second RU of the second set of the plurality of RUs, if a shuffled first subcarrier index k(n) falls within a second subcarrier index of the second set of the plurality of RUs, right shifting said shuffled first subcarrier index k(n) and following shuffled first subcarrier indices k(n+1), . . . k(e′ᵢ) by a length of total second subcarriers in the corresponding second RU.

As described above, N can correspond to a total subcarrier number of the first subcarriers in the first set of the plurality of RUs minus 1. The design method can further comprise removing a last one first subcarrier from a last first RU of the first set of the plurality of RUs before the shuffling and inserting the last one first subcarrier at an end of the last first RU of the first set of the plurality of RUs after the shuffling.

When the RUs in the first set of the plurality of RUs are sized equally, p can correspond to a total unit number of the first set of the plurality of RUs.

In some embodiments, the second set of the plurality of RUs can be arranged at an end of the PPDU.

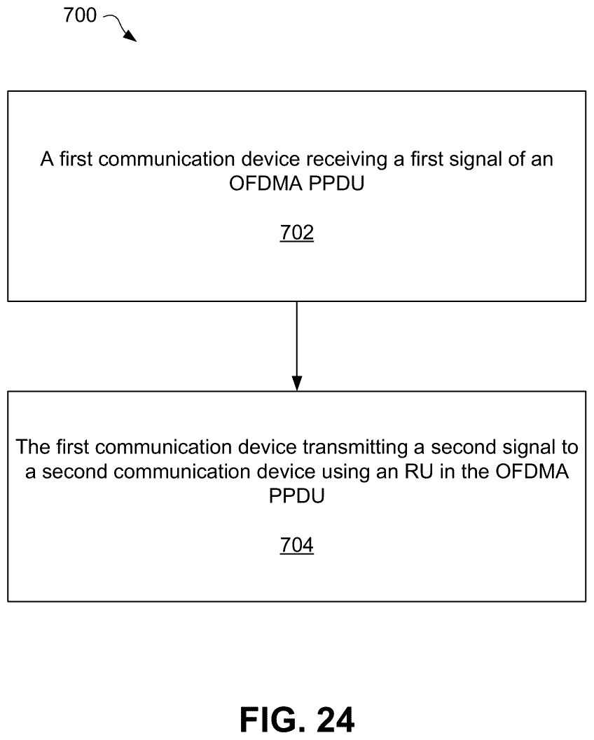

FIG. 24 is a flow chart of a second communication method (700), in accordance with some embodiments of the disclosure.

The second communication method (700) comprises a first communication device receiving (702) a first signal of an OFDMA PPDU; and transmitting (704) a second signal to a second communication device using an RU in the OFDMA PPDU. Each of the first and second communication devices can be an AP 102 or a STA 112.

The RU comprises a plurality of subcarriers; and the RU is one of a plurality of RUs of the OFDMA PPDU. The RU used by the first communication device belongs to either a first set (e.g., a set of DRUs) including at least one first RU or a second set (e.g., a set of RRUs) including at least one second RU. If the RU belongs to the first set, the plurality of subcarriers of the RU are same subcarriers determined in accordance with a design method that distributes the subcarriers, and if the RU belongs to the second set, the plurality of subcarriers of the RU are arranged consecutively. For example, the design method that distributes the subcarriers can be based on a relative prime interleaving method described with reference to FIG. 8(B).

The received first signal comprises resource allocation information of the plurality of RUs in the OFDMA PPDU. The plurality of subcarriers of the RU in the OFDMA PPDU are determined using the resource allocation information of the plurality of RUs in the OFDMA PPDU.

In some embodiments, the first signal can comprise at least one RU allocation field and an additional subfield. The at least RU allocation field can collectively indicate a size of each of the plurality of RUs in the OFDMA PPDU, and the plurality of subcarriers of the RU in the OFDMA PPDU can be determined using the at least one RU allocation field and the additional subfield.

In some embodiments, the additional subfield can comprise a first subfield for each RU in a user field of the first signal for indicating if the corresponding RU belongs to the first set or the second set. The first subfield may comprise one bit for each RU in the user field of the first signal for indicating if the corresponding RU belongs to the first or second set of the plurality of RUs.

In some alternative embodiments, the additional subfield can comprise a second subfield in a common field of the first signal for indicating a total number of second RUs in the second set of the plurality of RUs. The second subfield may comprise 1 to 8 bits.

In such embodiments, the second set of the plurality of RUs can be arranged at an end of the PPDU, as shown for example in FIG. 15.

In some alternative embodiments, each of the at least one RU allocation subfield can correspond to a subchannel of the OFDMA PPDU, and the additional subfield can comprise one additional bit in each of the at least one RU allocation subfield for indicating if RUs in a corresponding subchannel belong to the first or second set of the plurality of RUs.

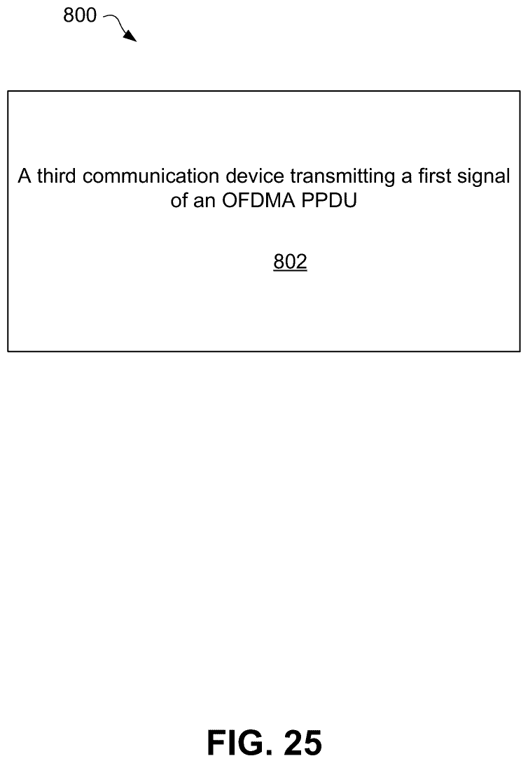

FIG. 25 is a flow chart of a third communication method (800), in accordance with some embodiments of the disclosure.

The third communication method (800) comprises a third communication device transmitting (802) a first signal of an OFDMA PPDU to the first communication device. The third communication device can be an AP 102.

The OFDMA PPDU comprises a plurality of RUs including a first set (e.g., a set of DRUs) including at least one first RU and a second set (e.g., a set of RRUs) including at least one second RU. Each first RU of the first set comprises a plurality of first subcarriers for data and/or pilot-symbol transmission and each second RU of the second set comprises a plurality of second subcarriers for data and/or pilot-symbol transmission. The plurality of first subcarriers of each first RU of the first set are same subcarriers determined in accordance with a design method that distributes the first subcarriers, and the plurality of second subcarriers of each second RU of the second set are arranged consecutively. For example, the design method that distributes the first subcarriers can be based on a relative prime interleaving method described with reference to FIG. 8(B).

The transmitted first signal comprises resource allocation information of the plurality of RUs in the OFDMA PPDU, the resource allocation information being used to determine parameters used in the design method that distributes the first subcarriers.

In some embodiments, the first signal can comprise at least one RU allocation field and an additional subfield. The at least RU allocation field can collectively indicate a size of each of the plurality of RUs in the OFDMA PPDU, and the parameters used in the design method that distributes the first subcarriers can be determined using the at least one RU allocation field and the additional subfield.

In some embodiments, the additional subfield can comprise a first subfield for each RU in a user field of the first signal for indicating if the corresponding RU belongs to the first or second set of the plurality of RUs. The first subfield may comprise one bit for each RU in the user field of the first signal.

In some alternative embodiments, the additional subfield can comprise a second subfield in a common field of the first signal for indicating a total number of second RUs in the second set of the plurality of RUs. The second subfield may comprise 1 to 8 bits.

In such embodiments, the second set of the plurality of RUs can be arranged at an end of the PPDU.

In some alternative embodiments, each of the at least one RU allocation subfield can correspond to a subchannel of the OFDMA PPDU, and the additional subfield can comprise one additional bit in each of the at least one RU allocation subfield for indicating if RUs in a corresponding subchannel belong to the first or second set of the plurality of RUs.

As described above, tone distribution design is important in a hybrid PPDU for the system performance and implementation. The various signaling methods as described above provide an effective way for the AP to transmit resource allocation information related to a hybrid PPDU to the STAs so that each STA can decode and determine the allocated RU and tone distribution for transmission using the allocated RU in the hybrid PPDU.

The methods, circuits, non-transitory computer-readable storage devices, and systems disclosed herein provide a systematic way to allocate or determine subcarriers (that is, tones) in a hybrid OFDMA PPDU including mixed RRUs and DRUs, each of which is for a specific STA, using a tone distribution method based on e.g., (modified) relative prime interleaving.

The various embodiments employing the hybrid OFDMA PPDU or mixed DRU & RRU can provide flexibility of RU allocations taking into consideration RUs that are designated for RRUs or for DRU incapable STAs. The hybrid OFDMA PPDU or mixed DRU & RRU, where DRUs and RRUs are used at the same time for an OFDMA PPDU transmission, can achieve higher throughput and better spectral efficiency. Moreover, DRU incapable STAs can be accommodated using the tone distribution method according to the embodiments. Various embodiments employing the hybrid OFDMA PPDU or mixed DRU & RRU can apply to a variety of PPDU bandwidths without limitations to the sizes of DRU segments and/or RRU segments.

The methods, circuits, non-transitory computer-readable storage devices, and systems disclosed herein also provide various signaling methods for transmission using a hybrid PPDU. The various signaling methods make use of current resource allocation field(s) and provide extra information in the signaling that can be used to determine the RU allocation of the hybrid PPDU and parameters used in the tone distribution methods of the DRUs.

By using the tone distribution method based on the (modified) relative prime interleaving, the indices for the hybrid PPDU can be generated or determined “on-the-fly” with easy implementation. Extra signaling information maintains a healthy balance between flexibility of the hybrid PPDU designs and signaling overhead.

The tone distribution and/or signaling methods disclosed herein may be related to the standardization of next generation of IEEE 802.11be for operation on the unlicensed millimeter bands.

The tone distribution and/or signaling methods disclosed herein may be used in WI-FI APs and STAs with operating capability in both sub-7 GHz and millimeter bands.

### D. Acronym Key

| | Acronym/Abbreviation/ |
|---|---|
| Full Name | Initialism |
| Access point | AP |
| Bandwidth | BW |
| Down link | DL |
| Equivalent isotropic radiated power | EIRP |
| Local Area Network | LAN |
| Medium Access Control Layer | MAC |
| Orthogonal frequency division | OFDMA |
| multiplexing access | |
| Physical Layer Protocol Data Unit | PPDU |
| Power spectral density | PSD |
| Receiver | Rx |
| Stations | STAs |
| Transmitter | Tx |
| Uplink | UL |
| Wireless LAN | WLAN |

Those skilled in the art will appreciate that, in some embodiments, the methods disclosed herein may be implemented as one or more circuits of a module, a device, an apparatus, a system, and/or the like. In some embodiments, the methods disclosed herein may be implemented as computer-executable instructions stored in one or more non-transitory computer-readable storage devices such that, the instructions, when executed, may cause one or more circuits to perform the methods disclosed herein.

Those skilled in the art will appreciate that the various embodiments and/or features disclosed herein may be customized and/or combined as needed or desired. Moreover, although embodiments have been described above with reference to the accompanying drawings, those of skill in the art will appreciate that variations and modifications may be made without departing from the scope thereof as defined by the appended claims.

What is claimed is:

1. A communication method comprising:
transmitting a signal to a device using a resource unit (RU) in an orthogonal frequency-division multiple access (OFDMA) physical layer protocol data unit (PPDU);
wherein the RU is one of a plurality of RUs of the OFDMA PPDU;
wherein the plurality of RUs comprises a first set including at least one first RU and a second set including at least one second RU, each first RU of the first set comprises a plurality of first subcarriers for data and/or pilot-symbol transmission and each second RU of the second set comprises a plurality of second subcarriers for data and/or pilot-symbol transmission; and
wherein the plurality of first subcarriers of each first RU of the first set are same subcarriers determined in accordance with a design method that distributes the first subcarriers, and the plurality of second subcarriers of each second RU of the second set are arranged consecutively.

2. The communication method of claim 1, wherein the design method comprises:
shuffling first subcarrier indices of the first subcarriers using a relative prime interleaving method.

3. The communication method of claim 2, wherein the design method further comprises:
for each first RU of the first set of the plurality of RUs, adjusting the first subcarrier indices of the first subcarriers of the first RU to be concatenated with a corresponding left neighboring first RU of the first set; and
wherein said shuffling the first subcarrier indices of the first subcarriers comprises shuffling the adjusted first subcarrier indices of the first subcarriers.

4. The communication method of claim 1, wherein the design method further comprises:
for each second RU of the second set of the plurality of RUs, if a distributed first subcarrier index falls within a second subcarrier index of the second set of the plurality of RUs, right shifting the distributed first subcarrier index and following distributed first subcarrier indices by a length of total second subcarriers in the corresponding second RU.

5. The communication method of claim 1, wherein the design method comprises:
for each first RUᵢ of the first set of the plurality of RUs, where i belongs to a unit index of the first set of the plurality of RUs:
adjusting [sᵢ:eᵢ] to [s′ᵢ:e′ᵢ] to be concatenated with their corresponding left neighboring first RUs of the first set, where sᵢ is a starting first subcarrier index of RUᵢ, eᵢ is an ending first subcarrier index of RUᵢ, s′ᵢ is an adjusted starting first subcarrier index of RUᵢ, and e′ᵢ is an adjusted ending first subcarrier index of RUᵢ;
shuffling a first subcarrier index of each first subcarrier within [s′ᵢ:e′ᵢ] using
$$k ( n ) = ( p \cdot n ) mod N$$
where n=s′ᵢ, . . . , e′ᵢ, k is a function of n, mod represents a modulo function, N is determined based on a total number of first subcarriers in the first set of the plurality of RUs, p is a minimum distance between two neighboring first subcarriers in each RU of the first set of the plurality of RUs and is a relative prime of N such that p and N have no common factors other than one; and
for each second RU of the second set of the plurality of RUs, if a shuffled first subcarrier index k(n) falls within a second subcarrier index of the second set of the plurality of RUs, right shifting said shuffled first subcarrier index k(n) and following shuffled first subcarrier indices k(n+1), . . . k(e′ᵢ) by a length of total second subcarriers in the corresponding second RU.

6. The communication method of claim 5, wherein:
N corresponds to a total subcarrier number of the first subcarriers in the first set of the plurality of RUs minus 1; and
the design method further comprises removing a last one first subcarrier from a last first RU of the first set of the plurality of RUs before said shuffling and inserting the last one first subcarrier at an end of the last first RU of the first set of the plurality of RUs after said shuffling.

7. The communication method of claim 6, wherein when the RUs in the first set of the plurality of RUs are sized equally, p corresponds to a total unit number of the first set of the plurality of RUs.

8. The communication method of claim 1, wherein the second set of the plurality of RUs are arranged at an end of the PPDU.

9. A communication method, comprising:
receiving a first signal of an orthogonal frequency-division multiple access (OFDMA) physical layer protocol data unit (PPDU); and
transmitting a second signal to a device using a resource unit (RU) in the OFDMA PPDU, the RU comprising a plurality of subcarriers;
wherein the RU is one of a plurality of RUs of the OFDMA PPDU;
wherein the RU belongs to either a first set including at least one first RU or a second set including at least one second RU;
wherein if the RU belongs to the first set, the plurality of subcarriers of the RU are same subcarriers determined in accordance with a design method that distributes the subcarriers, and if the RU belongs to the second set, the plurality of subcarriers of the RU are arranged consecutively; and
wherein the first signal comprises resource allocation information of the plurality of RUs in the OFDMA PPDU; and wherein the plurality of subcarriers of the RU in the OFDMA PPDU are determined using the resource allocation information of the plurality of RUs in the OFDMA PPDU.

10. The communication method according to claim 9, wherein the first signal comprises at least one RU allocation field and an additional subfield, wherein the at least RU allocation field indicates a size of each of the plurality of RUs in the OFDMA PPDU, and wherein the plurality of subcarriers of the RU in the OFDMA PPDU are determined using the at least one RU allocation field and the additional subfield.

11. The communication method of claim 10, wherein the additional subfield comprises a first subfield for each RU in a user field of the first signal for indicating if the corresponding RU belongs to the first set of the plurality of RUs or the second set of the plurality of RUs.

12. The communication method of claim 11, wherein the first subfield comprises one bit for each RU in the user field of the first signal for indicating if the corresponding RU belongs to the first set of the plurality of RUs or the second set of the plurality of RUs.

13. The communication method of claim 9, wherein the additional subfield comprises a second subfield in a common field of the first signal for indicating a total number of second RUs in the second set of the plurality of RUs.

14. The communication method of claim 13, wherein the second subfield comprises 1 to 8 bits for indicating the total number of second RUs in the second set of the plurality of RUs.

15. The communication method of claim 13, wherein the second set of the plurality of RUs are arranged at an end of the PPDU.

16. The communication method of claim 10, wherein each of the at least one RU allocation subfield corresponds to a subchannel of the OFDMA PPDU, and the additional subfield comprises one additional bit in each of the at least one RU allocation subfield for indicating if RUs in a corresponding subchannel belong to the first set of the plurality of RUs or the second set of the plurality of RUs.

17. A communication method, comprising:
transmitting a first signal of an orthogonal frequency-division multiple access (OFDMA) physical layer protocol data unit (PPDU);
wherein the OFDMA PPDU comprises a plurality of RUs, the plurality of RUs comprises a first set including at least one first RU and a second set including at least one second RU, each first RU of the first set comprises a plurality of first subcarriers for data and/or pilot-symbol transmission, and each second RU of the second set comprises a plurality of second subcarriers for data and/or pilot-symbol transmission; and
wherein the plurality of first subcarriers of each first RU of the first set are same subcarriers determined in accordance with a design method that distributes the first subcarriers, and the plurality of second subcarriers of each second RU of the second set are arranged consecutively; and
wherein the first signal comprises resource allocation information of the plurality of RUs in the OFDMA PPDU, and the resource allocation information is used to determine parameters used in the design method that distributes the first subcarriers.

18. The communication method according to claim 17, wherein the design method comprises:
shuffling first subcarrier indices of the first subcarriers using a relative prime interleaving method; and
the first signal comprises at least one RU allocation field and an additional subfield, wherein the at least RU allocation field indicates a size of each of the plurality of RUs in the OFDMA PPDU, and wherein the parameters used in the design method that distributes the first subcarriers are determined using the at least one RU allocation field and the additional subfield.

19. The communication method of claim 18, wherein the additional subfield comprises a first subfield for each RU in a user field of the first signal for indicating if the corresponding RU belongs to the first set of the plurality of RUs or the second set of the plurality of RUs.

20. The communication method of claim 19, wherein the first subfield comprises one bit for each RU in the user field of the first signal for indicating if the corresponding RU belongs to the first set of the plurality of RUs or the second set of the plurality of RUs.

21. The communication method of claim 18, wherein the additional subfield comprises a second subfield in a common field of the first signal for indicating a total number of second RUs in the second set of the plurality of RUs.

22. The communication method of claim 21, wherein the second subfield comprises 1 to 8 bits for indicating the total number of second RUs in the second set of the plurality of RUs.

23. The communication method of claim 18, wherein each of the at least one RU allocation subfield corresponds to a subchannel of the OFDMA PPDU, and the additional subfield comprises one additional bit in each of the at least one RU allocation subfield for indicating if RUs in a corresponding subchannel belong to the first set of the plurality of RUs or the second set of the plurality of RUs.
